(19) United States
(12) Patent Application Publication
(10) Pub. No.: US 2025/0148530 A1
(43) Pub. Date: May 8, 2025

(54) LOAN APPLICATION PLATFORM SYSTEMS, METHODS, AND APPARATUS

(71) Applicant: ConnexMarkets, Inc., Madison, CT (US)

(72) Inventor: Timothy Clorite, Madison, CT (US)

(73) Assignee: ConnexMarkets, Inc., Madison, CT (US)

(21) Appl. No.: 18/935,176

(22) Filed: Nov. 1, 2024

Related U.S. Application Data
(60) Provisional application No. 63/547,215, filed on Nov. 3, 2023.

(51) Int. Cl. G06Q 40/03

(52) U.S. Cl. CPC G06Q 40/03

(57) ABSTRACT

A lending system includes lender accounts stored in a database. Each of the lender accounts includes a loan profile for one or more types of commercial loans including a loan type, loan amount, loan rate or other loan terms and required financial metrics of a borrower. The lending system obtains loan application data from a commercial borrower, e.g., through a lender/borrower/specialist web portal, which manages the loan process between the borrower and the lender from origin into the closing of the loan with all data and communication internal. The lending system compares the loan application data with the loan profiles from the lender accounts and determines matching loan profiles. The lending system provides access to the loan application to the lender accounts with matching loan profiles, e.g., through a lender web portal. The lender web portal obtains data for non-binding loan offers from the lender accounts with matching loan profiles.

### CROSS-REFERENCE TO RELATED APPLICATIONS

This application claims priority under 35 U.S.C. § 119 to U.S. Provisional Patent Application entitled, “LOAN APPLICATION PLATFORM SYSTEMS, METHODS, AND APPARATUS,” having Ser. No. 63/547,215, and filed on Nov. 3, 2023, which is hereby incorporated by reference in its entirety as if fully set forth herein.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Currently, it is very difficult for a business seeking a commercial loan to select multiple potential lenders, submit applications to the multiple lenders, and obtain competitive loan offers from the multiple lenders. Prior art loan application systems typically have included two components: a basic initial loan calculator and a subsequent loan application account portal. A conventional prior art loan calculator typically is available to a potential borrower without logging on to a user account of the system, in which the loan calculator allows the potential borrower to enter a proposed loan amount, business information, location, business type and then the loan calculator outputs estimates of a potential interest rate and a monthly-installment repayment amount. Such estimates are not actual loan proposals, nor binding offers specific to the user as a potential borrower. If the potential borrower is interested in pursuing an actual loan application, and receive an actual loan proposal, under the prior art, the potential borrower then creates a user account and enters a significant amount of information to then only receive a loan proposal from the lender.

With these prior art systems, a borrower has no method of determining which lenders may be interested in their desired loan based on their business' financial status and requested loan terms. Second, a business must complete an extensive loan application with lengthy and detailed documentation for a potential lender and only then obtain a term sheet or any indication of success of the loan from that potential lender after creating an online account. To obtain multiple offers, the business must repeat this extensive application process with multiple potential lenders. Since this process takes so long, a business often applies to one lender and settles for a first offer of a commercial loan with no other competitive offers.

From the viewpoint of the lender of commercial loans, the prior art systems require lengthy and detailed data acquisition from each potential borrower, without first determining if the potential borrower meets initial criteria of the lender. Potential borrowers may not exit the application process because it is taking too long or appearing to require a commitment too soon from the potential borrowers before providing relevant loan information. It is difficult for the lender to determine early in the process the borrower applications that match their desired client criteria and loan terms. The lender must meet with each individual business seeking a business loan, obtain and review extensive applications without first knowing whether the financial data of the business meets their loan criteria. The lender thus wastes time and loses efficiency obtaining and reviewing extensive data from potential borrowers that do not meet their loan criteria.

Thus, there is a need for an improved system of loan origination and loan application process for both potential borrowers and lenders of commercial loans.

### BRIEF SUMMARY OF THE INVENTION

In one aspect herein, a lending system includes at least one memory device, wherein the memory device stores a database including a plurality of loan profiles generated by a plurality of lenders, wherein each of the plurality of loan profiles includes a loan type, loan metrics, and borrower metrics and wherein the loan type includes a type of commercial loan. The lending system further includes at least one processing circuit, wherein the processing circuit is operatively coupled to the at least one memory device and wherein the at least one memory device stores instructions that, when executed by the at least one processing circuit, causes the lending system to: obtain borrower data including a plurality of business metrics from a user device; compare the borrower data to the plurality of loan profiles of the plurality of lenders; determine at least one matching loan profile from the plurality of loan profiles; determine loan terms from the at least one matching loan profile, wherein the loan terms include at least a loan amount and a loan rate;

and generate a graphical user interface (GUI) file for display on the user device, wherein the GUI file includes the loan terms.

In another aspect herein, a lending system includes at least one memory device; and at least one processing circuit, wherein the processing circuit is operatively coupled to the at least one memory device and wherein the at least one memory device stores instructions that, when executed by the at least one processing circuit, causes the lending system to generate a lender web portal for access by a plurality of lender accounts; generate a plurality of loan profiles for each of the plurality of lender accounts, wherein each of the plurality of loan profiles includes a loan type, loan metrics, and borrower metrics and wherein the loan type includes a type of commercial loan; generate loan application data using borrower data associated with a borrower account and store the loan application data in the at least one memory device; compare the loan application data to the loan metrics and the borrower metrics in each of the plurality of loan profiles; and determine a plurality of matching loan profiles from the plurality of loan profiles.

In one or more of the above aspects, the lending system is further configured to generate a borrower account including the initial borrower data; generate loan application data using additional borrower data associated with a borrower account and store the loan application data in the at least one memory device; and determine a plurality of updated matching loan profiles from the plurality of loan profiles stored in the at least one memory device using the loan metrics and the borrower metrics from the plurality of loan profiles and the loan application data.

In one or more of the above aspects, the lending system is further configured to determine a plurality of matched lenders associated with the plurality of updated matching loan profiles and provide access to the loan application data stored in the at least one memory device to lender accounts associated with the plurality of matched lenders.

In one or more of the above aspects, the lending system is further configured to determine the plurality of updated matching loan profiles by determining a matching score between the loan application data and each of the plurality of loan profiles; comparing the matching score for each of the plurality of loan profiles to a minimum matching score; and selecting the plurality of updated matching profiles with associated matching scores above the minimum matching score.

In one or more of the above aspects, the lending system is further configured to obtain and store a plurality of non-binding term sheets (NBTS) from a plurality of the matched lenders and provide access to the plurality of NBTS to the borrower account.

In one or more of the above aspects, the lending system is further configured to obtain a selection of one of the plurality of NBTS from the borrower account; notify a selected lender associated with the selected one of the plurality of NBTS; and notify a plurality of non-selected lenders of a stand-by status.

In one or more of the above aspects, the lending system is to track a status of the loan application.

In one or more of the above aspects, the lending system is further configured to generate a customizable template for a loan application GUI; receive updates to the customizable template from a lender account; and generate an updated template for the loan application GUI for the lender account.

In one or more of the above aspects, the lending system is further configured to obtain one or more parameters relating to lender performance and generate a rating of a lender account using the one or more parameters.

In one or more of the above aspects, the lending system is further configured to generate a template of a pro forma financial statement for one or more business types; extract data associated with the borrower account from a third-party accounting system; and generate a pro forma financial statement for the borrower account using the extracted data and loan terms from the at least one matching loan profile.

In one or more of the above aspects, the lending system is further configured to generate a loan probability score using the plurality of business metrics, a loan amount, and a number of matching loan profiles, wherein the loan probability score measures a probability of obtaining a loan.

In one or more of the above aspects, the lending system is further configured to determining a matching score between the loan application data and each of the plurality of loan profiles; comparing the matching score for each of the plurality of loan profiles to a minimum matching score; and determining the plurality of loan profiles with associated matching scores above the minimum matching score.

In one or more of the above aspects, the lending system is further configured to determine a plurality of matched lenders associated with the plurality of matching loan profiles; and provide access to the loan application data stored in the at least one memory device to lender accounts associated with the plurality of matched lenders.

In one or more of the above aspects, the lending system is further configured to generate a borrower web portal for access by a plurality of borrower accounts and generate one or more graphical user interfaces (GUIs) for input of the borrower data by the associated borrower account, wherein the associated borrower account is one of the plurality of borrower accounts.

In one or more of the above aspects, the lending system is further configured to generate a loan specialist web portal for access by a plurality of loan specialists and generate a GUI for the loan specialist web portal including a loan status for each of a plurality of loan applications associated with the plurality of borrower accounts.

In one or more of the above aspects, the lending system is further configured to generate a GUI for the loan specialist web portal including a plurality of process steps and a status for each of the plurality of process steps for each of the plurality of loan applications associated with the plurality of borrower accounts.

### BRIEF DESCRIPTION OF THE DRAWINGS

By reference to the appended drawings, which illustrate exemplary embodiments of this invention, the detailed description provided below explains in detail various features, advantages, and aspects of this invention. As such, features of this invention can be more clearly understood from the following detailed description considered in conjunction with the following drawings, in which the same reference numerals denote the same, similar, or comparable elements throughout. The exemplary embodiments illustrated in the drawings are not necessarily to scale or to shape and are not to be considered limiting of its scope, for the invention may admit to other equally effective embodiments having differing combinations of features, as set forth in the accompanying claims.

FIG. 1 illustrates a block diagram of an exemplary network system with an application server, according to one or more embodiments herein.

FIG. 2 illustrates a block diagram of an exemplary embodiment of a lending system including the application server and one or more database devices, according to one or more embodiments herein.

FIG. 3 illustrates a flow chart of an exemplary embodiment of a method of the lending system, according to one or more embodiments herein.

FIG. 4 illustrates a block diagram of an exemplary embodiment of the application server, according to one or more embodiments herein.

FIG. 5 illustrates a flow chart of an exemplary embodiment of a method of the lending system for generation of a common loan application, according to one or more embodiments herein.

FIGS. 6A-E illustrate exemplary embodiments of graphical user interfaces (GUIs) of the borrower web portal in accordance with an embodiment of the lending system, according to one or more embodiments herein.

FIG. 7 illustrates a flow chart of an exemplary embodiment of a method for processing a completed loan application by the lending system, according to one or more embodiments herein.

FIG. 8 illustrates a flow chart of an exemplary embodiment of another method for processing a completed loan application by the lending system, according to one or more embodiments herein.

FIG. 9 illustrates an exemplary embodiment of a GUI in the loan specialist web portal generated by the lending system, according to one or more embodiments herein.

FIG. 10 illustrates an exemplary embodiment of another GUI in the loan specialist web portal generated by the lending system, according to one or more embodiments herein.

FIG. 11 illustrates an exemplary embodiment of yet another GUI in the loan specialist web portal generated by the lending system, according to one or more embodiments herein.

FIG. 12 illustrates a flow chart of an exemplary embodiment of a method of the lender web portal by the lending system, according to one or more embodiments herein.

FIGS. 13A-D illustrate exemplary embodiments of GUIs in the lender web portal generated by the lending system, according to one or more embodiments herein.

FIG. 14 illustrates a flow chart of an exemplary embodiment of a method for rating lender accounts in the lending system, according to one or more embodiments herein.

FIG. 15 illustrates a flow chart of an exemplary embodiment of a method for generating a borrower accounting file module, according to one or more embodiments herein.

FIG. 16 illustrates a block diagram of an exemplary embodiment of a method of the network system, according to one or more embodiments herein.

FIG. 17 illustrates a flow chart of an exemplary embodiment of a method of the lender system for generating a company overview service, according to one or more embodiments herein.

### DETAILED DESCRIPTION

The subject application references certain processes which are presented as series of ordered steps. The steps described with respect to these processes are not to be understood as enumerated consecutive lists but could be performed in various orders while still embodying the invention described herein.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

An online commercial loan origination and application platform and lender loan management platform is described herein. The lending system enables connections between borrowers and loan lenders. Lenders register with the lending system and generate one or more loan profiles for one or more types of loan. The lending system facilitates completing a common loan application from a potential borrower and comparing the loan profiles to the common loan application to determine a plurality of matching loan profiles. The loan system provides the common loan application to the potential lenders with matching loan profiles. The lending system facilitates obtaining multiple non-binding term sheets from the potential lenders. The platform generates a lender matching score of a percentage match between a lender's predetermined loan criteria and a loan application of the potential borrower.

The lending system facilitates approval of one of the multiple non-binding loan terms by the borrower. During due diligence and closing, the lending system provides a secure folder in which to upload, store and share supporting documentation. The lending system may be adapted to offer to extract data, or receive a data extract, from an accounting application, such as QuickBooks® software, to provide a more complete data submission and reduce the volume of data entry required of a borrower. The lending system tracks the loan application to closing.

The lending system thus provides advantages over previous solutions to both borrowers and lenders. The borrower only needs to complete a single loan application to determine a plurality of lenders with matching loan profiles. The borrower is thus able to submit the common loan application to the multiple lenders and obtain competitive loan offers from the multiple lenders. The lenders receive prescreened loan applications from borrowers that match their loan criteria.

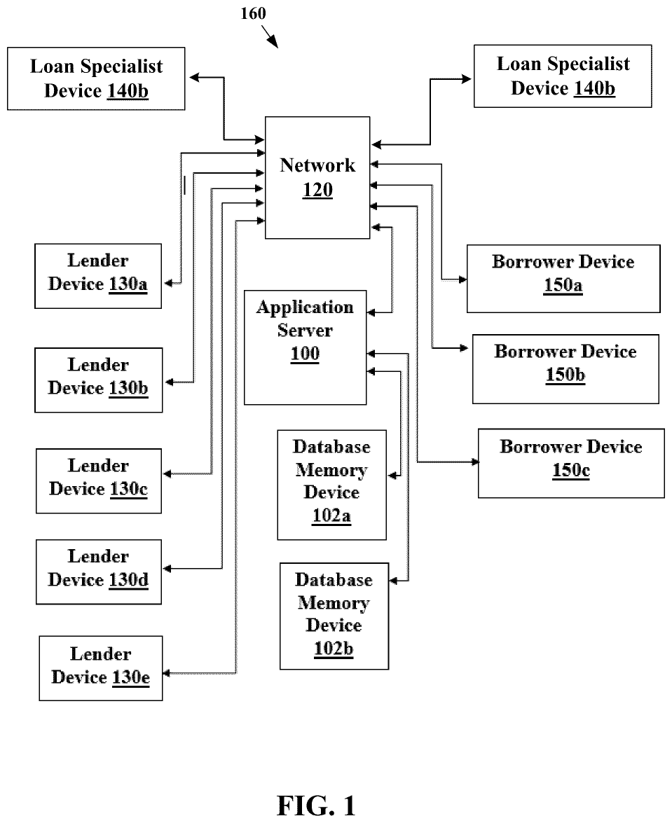

FIG. 1 illustrates a block diagram of an exemplary network system 160 with at least one application server 100 for implementation of an exemplary embodiment of the present invention. A plurality of lender devices 130a-e, loan specialist devices 140a-b, and borrower devices 150a-c are configured to communicate with the application server 100 over network 120, e.g. using a client/server architecture or a software as a service (SaaS) architecture. The lender, loan specialist and borrower devices 130, 140, 150 may include general-purpose or special-purpose computing devices, such as personal computers (“PCs”), server computers, handheld or laptop devices, multi-processor systems, microprocessor-based systems, network PCs, minicomputers, mainframe computers, cell phones, smartphones, tablets, embedded systems, distributed computing environments that include any of the above systems or devices, and the like. In their most basic configuration, the devices 130, 140, 150 each include at least one processing unit and at least one memory unit. The devices 130, 140, 150 may also have input device(s) and output devices such as keyboard, mouse, pen, mouse, voice input device, touch input device, a display, speakers, LED light, etc. In an embodiment, the devices 130, 140, 150 are web-enabled devices configured with a web browser.

The network 120 includes one or more networks that communicatively couple the application server 100 and the devices 130, 140, 150 and may include, e.g., a wide area network (WAN) and/or a wireless wide area network (Wireless WAN). For example, the WAN may include the Internet, service provider network, satellite WAN, or a combination of one or more thereof. The Wireless WAN may include a cellular network, such as a 4G or 5G cellular network. The WAN or Wireless WAN are communicatively coupled directly to the devices 130, 140, 150 or coupled to the devices through an edge network and/or local area network (LAN), e.g., including a router, bridge, cable network, or a WLAN access point (AP) or another type of network or devices. The one or more networks 120 work to communicatively couple the devices 130, 140, 150 to the application server 100. Alternate networks and/or methods of communicating information may be substituted without departing from the scope hereof.

The application server 100 may include a network interface having one or more transceivers for wireless and/or wired network communications with one or more of the devices 130, 140, 150 over the network 120. The application server 100 may communicate with the one or more memory devices 102a-b directly or over a private local area network or via the one or more networks 120. Each of the memory devices 102a-b may be a database server or other device including RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, cloud devices, or any other medium which can be used to store the desired information and which can be accessed by the application server 100.

Though a single application server 100 is illustrated, multiple application servers may be implemented to perform the functions of the application server 100 described herein. Moreover, this exemplary network system 160 is only one example of a suitable computing environment, and additional and/or alternative data networks, devices, and communication protocols may be implemented herein.

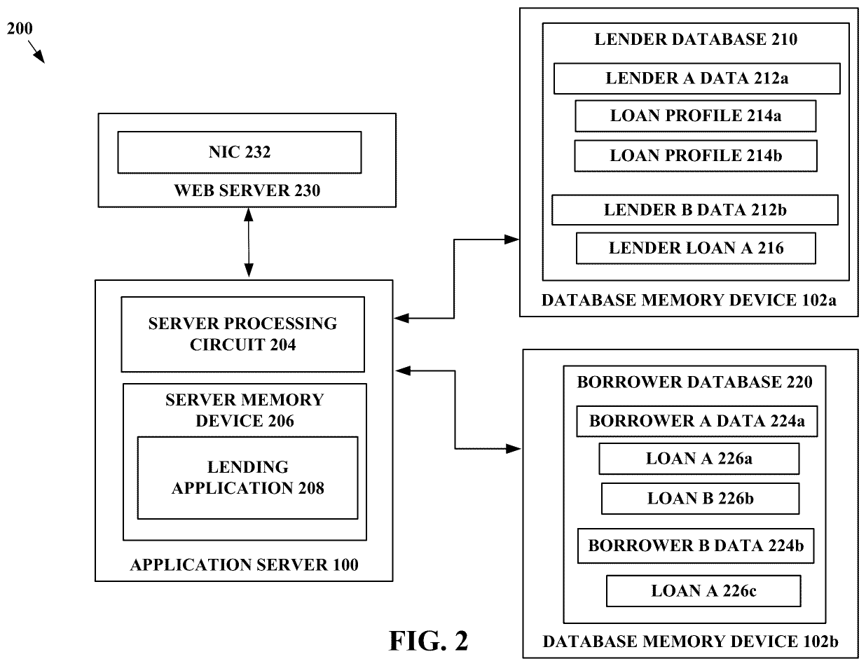

FIG. 2 illustrates another embodiment of the lending system 200 including the application server 100 and the one or more memory devices 102a-b. The application server 100 includes a server processing circuit 204. The server processing circuit 204 includes at least one processor, such as a central processor unit (CPU), microprocessor, microcontroller, embedded processor, digital signal processor, media processor, field programmable gate array, programmable logic device, state machine, logic circuitry, analog circuitry, digital circuitry, and/or any device that manipulates signals (analog and/or digital) based on hard coding of the circuitry and/or operational instructions.

The application server 100 includes a server memory device 206 that stores the lending application 208. The server memory device 206 includes non-volatile computer-readable media, including any read-only memory, random access memory, volatile memory, non-volatile memory, static memory, dynamic memory, flash memory, cache memory, and/or any non-transitory memory device that stores digital information or any other medium that can be used to store the desired information, and that can be accessed by application server 100. The lending application 208 includes computer-executable instructions such as program modules, routines, programs, objects, components, data structures, or other programming, that when executed by the processing circuit 204, cause the lending system 200 to perform one or more functions described herein.

The lending system 200 further includes one or more databases 210, 220, which may be structured query language (“SQL”) database(s), PostgreSQL, Microsoft® SQL Server 2008 MySQL, Microsoft® Access®, or Oracle databases, with a relational database management system, such as MySQL as is commonly known and used in the art. Though the lender database 210 and the borrower database 220 are shown stored externally to application server 100 on memory devices 102a-b, such databases may be stored internally on application server 100, stored on a single external memory device 102, or may be combined into one database or separated into any number of databases or any other operable configuration. The lending system 200 thus includes a special purpose processing system configured for provision of the lending application to one or more devices 130, 140, 150.

In an embodiment, the lender database 210 includes data for a plurality of potential lenders 212a-b. The data may include loan profiles 214a-b that describe a designated type of loan, borrower metrics and loan metrics. The loan profiles 214a-b are selected and/or entered by a potential lender using the lending system 200. The loan metrics include, e.g., loan amount and loan terms offered by a lender. The borrower metrics include required values or ranges of values of financial data of a borrower. The lender database 210 further includes lender loan data 216 that includes data for matched loan applications and status of the matched loan applications. The data stored in the lender database 210 is described in more detail herein and is exemplary. Additional or alternate data may also be obtained and stored by the lending system 100.

In an embodiment, a borrower database 220 includes data for a plurality of borrowers 224a-b. The borrower data 224 includes, e.g., borrower profile information, such as name and address of the company. For each registered borrower account 224, data for one or more loan applications 226a-c may be stored. The loan application data 226 includes, e.g., business metrics of the borrower. The data stored in the borrower database 220 is described in more detail herein and is exemplary. Additional or alternate data may also be obtained and stored by the lending system 100.

A web server 230 may be implemented to interface between the application server 100 and the network 120. The web server 230 includes a network interface card (NIC) 232 having one or more transceivers for wireless and/or wired network communications with one or more of the devices 130, 140, 150 over the network 120 in the computing environment 160. The NIC 232 may also include authentication capability that requires an authentication process prior to allowing access to some or all of the resources of the application server 100. The NIC 232 may also include firewall, gateway, availability and/or security functions. The web server 230 communicates with third party devices over one or more public networks, such as in network 120. Though not shown, the web server 230 may also include a server processing circuit 204 and server memory device 206, wherein the memory device 206 in the web server 230 includes computer-executable instructions such as program modules, routines, programs, objects, components, data structures, or other programming, that when executed by the processing circuit 204 in the web server 230, cause the web server 230 to perform one or more functions described herein.

In an embodiment, the user devices 130, 140, 150 are equipped with one or more web browsers that interact with the web server 230 via a HyperText Transfer Protocol (“HTTP”) and/or a secure version (e.g., “https”) of a related Uniform Resource Locator (“URL”). The lending application 308 and services it provides are accessible using the web browsers on the user devices 130, 140, 150 via the network 120, e.g., using the publicly addressable URL. The lending system 200 then acts as a software as a service (SaaS) provider. The web server 230 may provide one or more different web portals, e.g., web-based platforms for access to the services and data of the lending system 200.

The system 160 may further use blockchain based, metaverse, or other technical architecture which allows the devices 130, 140, 150 to access and use applications stored on the application server 100. However, alternate methods of computing device/server communications may be substituted without departing from the scope hereof.

In an embodiment, the web server 230 communicates with the application server 100 over a private network. Similarly, the application server 100 communicates with the database memory devices 102a-b over the private network. This tiered architecture of the web server 230 and application server 100 is more secure as external third-party devices, such as lender devices 130a-n and borrower devices 150a-n, do not directly access sensitive data in the memory devices 102a-b. The web server 230 provides an interface for communication between the application server 100 and the third party devices. The application server 100 may then access any requested data stored on the memory devices 102a-b and provide the requested data to the web server 230, e.g., for communication to the third party devices.

The servers, memory devices, and databases shown in FIGS. 1-2 are merely exemplary, and the servers and/or databases may be omitted, added, or substituted without departing from the scope of the present invention. In addition, different system architectures may be implemented that perform the functions described herein.

As described herein, the lending system 200 provides a special purpose computing system with new technology and functions for provision of the new methods described herein. The lending system 200 includes significant additional elements with tangible physical form and provides a practical application for performing one or more unique methods described herein that may only practically be performed by a computing system, considering the multitude of data (such as the plurality of borrowers, loans, lenders, etc.), the required complex analysis, and the generation of computer implemented web portals and GUIs with new functionality, and communications with remote, third party systems.

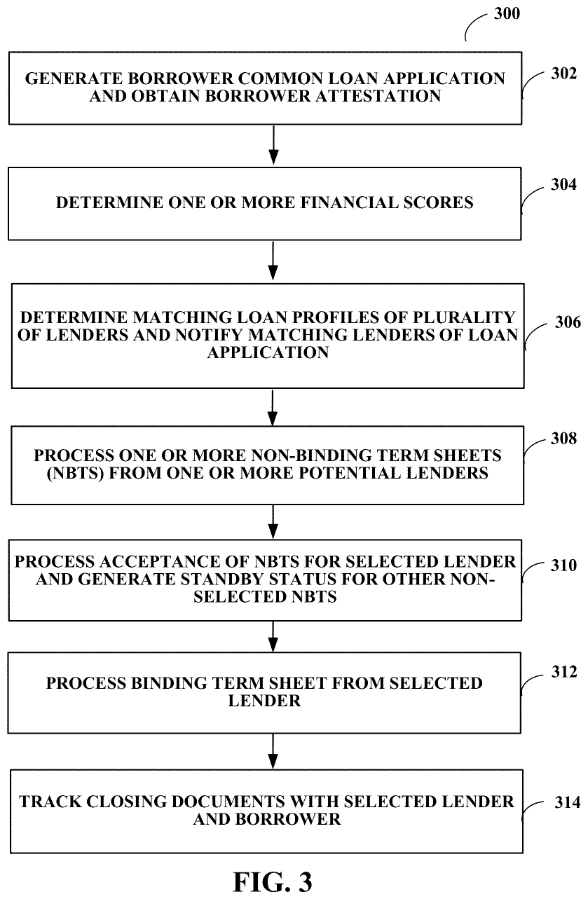

FIG. 3 illustrates a high level flow chart of an exemplary method 300 of the lending system 200. These steps or functions of the lending system 200 are exemplary and described in more detail herein. At 302, the lending system 200 generates a common loan application for completion by a potential borrower. The borrower may include a commercial entity, meaning a legal business entity, such as a corporation, partnership, limited partnership, proprietorship, sole proprietorship, non-profit, firm, enterprise, franchise, or association that performs a commercial activity. In another embodiment, the borrower may include an individual, group, or collection of one or more individuals.

In one embodiment, the lending system 200 may provide one or more GUIs (e.g., such as HTML files) in the borrower web portal 420 for the potential borrower to enter business metrics and/or requested loan amount and terms. In another embodiment, the lending system 200 interacts with an application downloaded to the user device. The lending system 200 may also present one or more GUIs in which potential borrowers can securely upload supporting documentation to a designated drop box, such as a secure private folder, e.g., on one or more of the memory devices 102a-b. The lending system 200 limits access to data in the secure private folder, e.g., to authorized users of the borrower and/or lenders. The lending system 200 may also include application program interfaces (APIs) to interface and extract data, or receive a data extract, from one or more accounting applications, such as QuickBooks® software, to reduce the volume of data entry required of the borrower. The lending system 200 generates a common loan application using the data input from the borrower at 302. The lending system 200 provides the common loan application for review by the borrower and obtains an attestation of the common loan application from the borrower, e.g. using an online document execution system, or generating one or more GUIs to obtain a digital attestation.

At 304, the lending system 200 may also use the data input by the borrower to determine one or more scores or probabilities, such as, a business financial health score, a score that indicates a balance sheet health of the borrower and/or a loan probability score indicating the estimated probability of obtaining a loan. These scores may be updated as further data is obtained by the lending system 200 during the generation of the common loan application process. For example, as further business metrics are entered by a borrower, or lenders respond to the loan application, the scores may be updated by the lending system 200.

At 306, the lending system 200 compares the common loan application with a plurality of loan profiles from a plurality of lenders, e.g., stored in the lender database 210. Based on the comparison, the lending system 200 determines one or more matching loan profiles. The determination may require that certain parameters in the loan profile match the same parameters in the common loan application (such as, type of loan or type of business). The borrower and/or lender may select the required parameters that must be matched for notification. In addition, the determination may require at least a predetermined percentage of parameters in the common loan application matches the parameters in the loan profiles. A minimum loan matching percentage (such as 60%) may be determined by the lender and/or the lending system 200. The lending system 200 thus determines the loan profiles with matching required parameters and with a minimum loan matching percentage. The lending system 200 then notifies lenders with matching profiles of the loan application. The notifications may be implemented using an automated mailbox application and/or through a lender web portal.

The lending system 200 provides access to the loan application to the lenders with matching profiles. For example, the lending system 200 includes the loan application on a graphical user interface (GUI) in a lender web portal 440 for access by the lender. The lending system 200 also provides tracking for a lender of matching loan applications. For example, the status of the matching loan applications may be marked as “new loan” until accessed by the lender account in the lender web portal 440. Then the status may be updated to “in review”.

In response to the loan application, the lenders may submit non-binding term sheets to the potential borrower via the lending system 200. The lending system 200 may provide one or more GUIs in the lender web portal with data fields to enter data or select one or more parameters, such as loan amount, amortization, monthly payment, total fees, number of covenants, interest rate, closing date, lender rating, etc. Alternatively, and/or additionally, the lending system 200 may provide a secure private folder, e.g., on one or more of the memory devices 102, to upload the non-binding term sheets.

The lending system 200 processes the non-binding term sheets (NBTS) from the plurality of lenders at 308, such as by determining that the NBTS match any required parameters. The lending system 200 notifies the borrower of the NBTS and provides access to the NBTS. The borrower then has an opportunity to review NBTS from a plurality of lenders by completing a single loan application.

The lending system 200 receives an acceptance of one of the NBTS from the borrower at 310. The lending system 200 notifies the selected lender of acceptance of its NBTS. The lending system 200 further notifies the other non-selected lenders and generates a standby status for the non-selected NBTS.

The lending system 200 then receives and processes a binding term sheet from the selected lender and provides access to the binding term sheet to the borrower at 312. For example, the lending system 200 provides access to the binding term sheet in the borrower account of the borrower web portal. The lending system 200 tracks the closing process and documents between the selected lender and borrower at 314.

The lending system 200 thus is configured to automatically request, collect, and process the business metrics of a borrower and generate a business loan application, and present such business loan application to a plurality of participating lenders. The lending system 200 thus expedites loan application consideration, approval or rejection, and funding of approved applications. The lending system 200 may also generate one or more scores, such as, a business financial health score, a score that indicates a balance sheet health of the borrower and/or a loan probability score indicating the estimated probability of obtaining a loan.

In addition to the largely automated online portal, the lending system may be supported by an array of employees, representatives, brokers, and/or contractors (“loan specialists”), who can arrange calls and communications between potential borrowers, participating lenders, and relevant partners. The loan specialists may perform investigative and decision-making activities, such as due diligence to clear a loan application or loan funding, and make sure each process of a loan application completion, submission, consideration, proposal, acceptance, execution, and funding is completed. The loan specialists may help potential borrowers and lenders move from a non-binding term sheet to a completed loan.

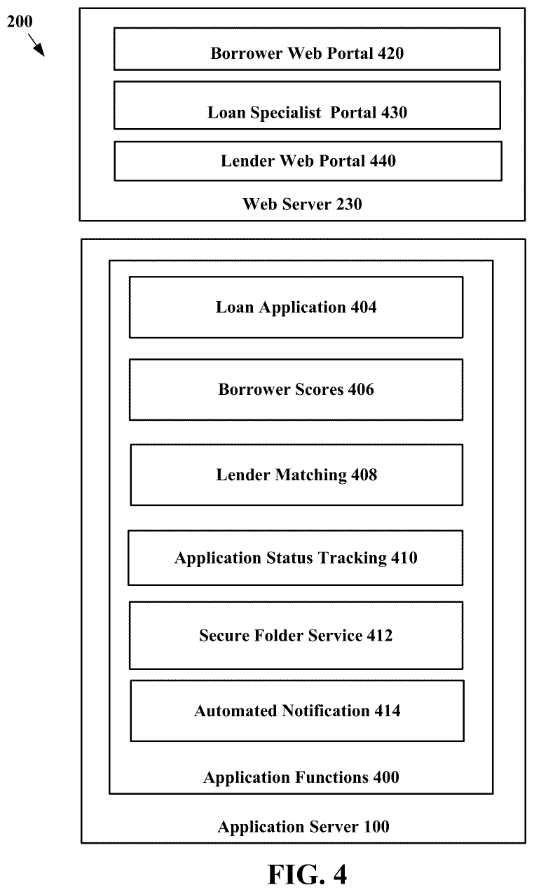

FIG. 4 illustrates a block diagram of another exemplary embodiment of the lending system 200 according to one or more embodiments herein. The web server 230 includes a borrower web portal 420, and a loan specialist web portal 430 and a lender web portal 440. The web portals provide specially designed, web-based platforms for authorized users of the lenders, borrowers and loan specialists, respectively. For example, the authorized users of the borrower web portal 420 includes employees or agents of a “borrower”, such as a potential borrower making loan inquiries, loan applicants, and actual borrowers having borrowed loan funds. The authorized users of the lender platform 440 include employees or agents of “lenders”, which may include potential, future, and/or past participating lenders, current participating lenders, and actual lenders that have lent actual loan funds. The authorized users of the loan specialist web portal include agents or employees of the operator of the lending system 200, such as customer service representatives having loan processing knowledge. The web portals may include one or more web-based platforms that may only be accessed by authorized users.

The application server 100 includes a plurality of sub-systems and functions 400 to support the lending system 200. The application functions 400 may be implemented on the application server 100 or as a service on third-party servers. The loan application function 404 generates the common loan application. The borrower scores function 406 calculates one or more scores or probabilities, such as, a business financial health score, a score that indicates a balance sheet health of the borrower and/or a loan probability score indicating the estimated probability of obtaining a loan. The lender matching function 408 determines the loan profiles matching the common loan application. The application status tracking function 410 determines a status of the loan application for each of the borrowers, loan specialists, and matching lenders. The secure folder service 412 provides secure folders for uploading of documents and data by lenders and borrowers and file sharing and synchronization services and may be provided by a third party, such as from DropBox® hosting service. The automated notification function 414 automatically generates email and/or text notifications to borrowers, lenders and loan specialists, e.g., in response to loan status changes or other designated actions in the lending system 200.

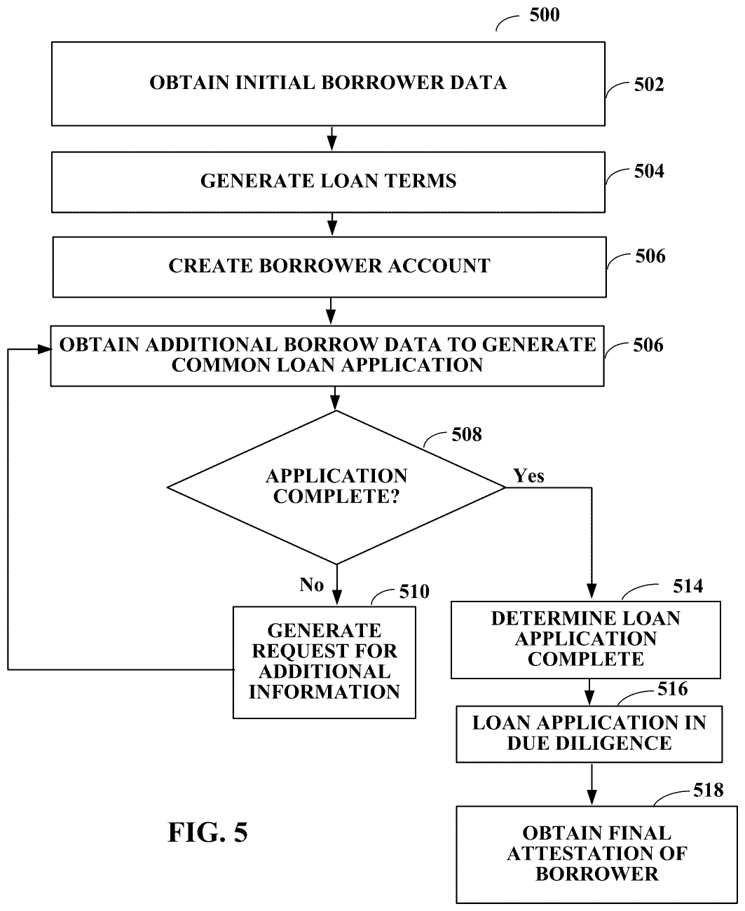

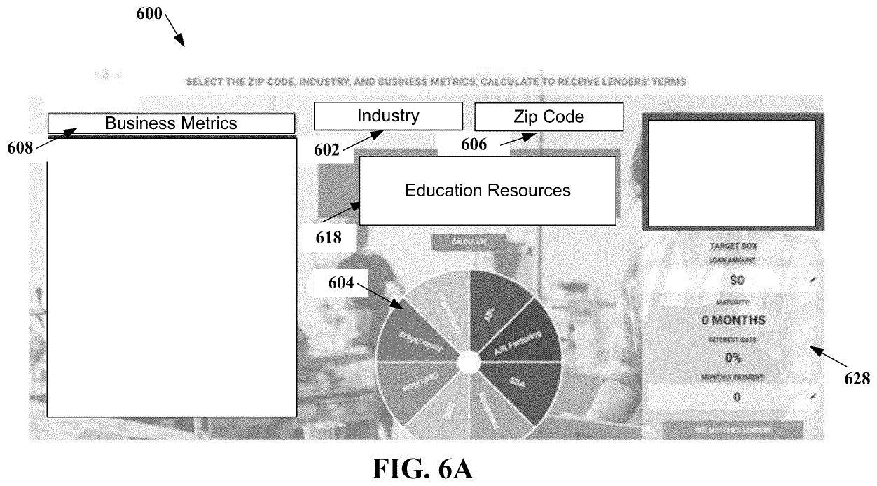

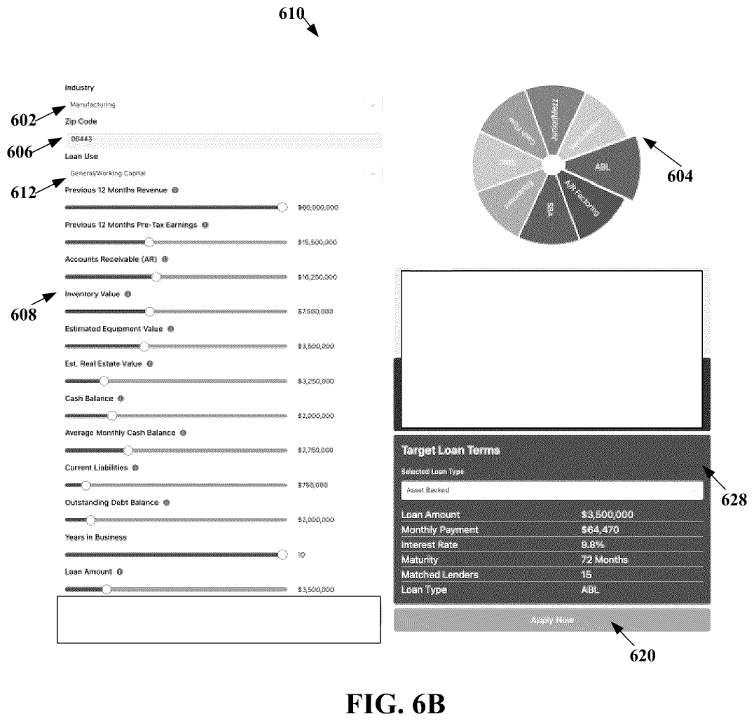

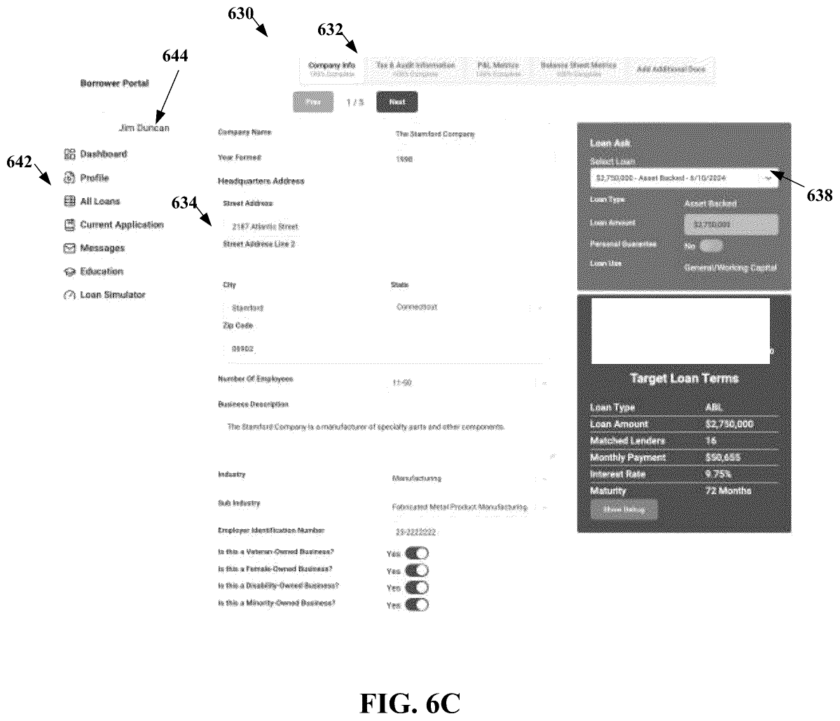

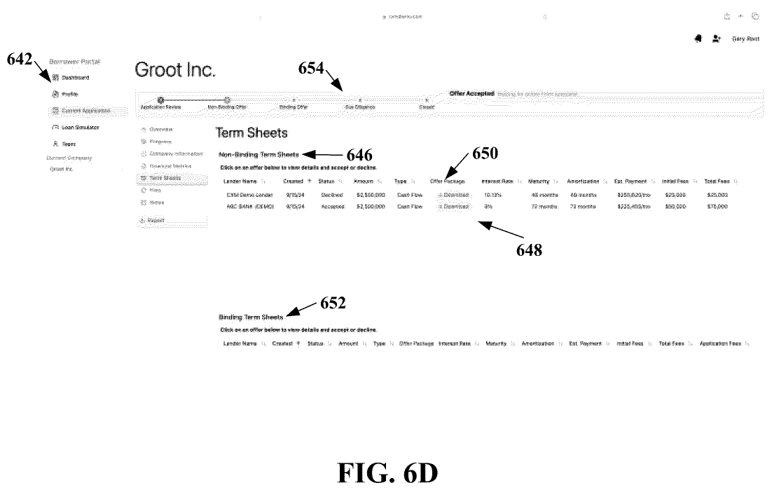

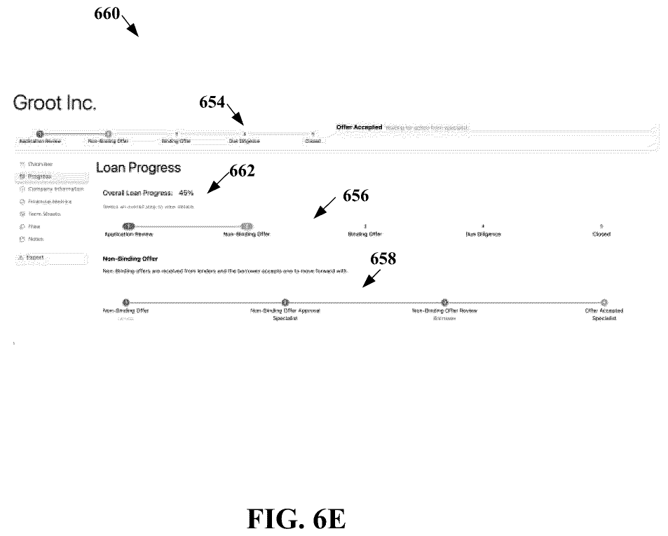

FIG. 5 illustrates a flow chart of an exemplary embodiment of a method 500 of the lending system 200 for generation of a common loan application for potential borrowers. At 502, the lending system 100 obtains initial borrower data, e.g., from a borrower device 150a-c. The lending system 200 generates one or more GUIs in a borrower web portal or a borrower application for input of business metrics by the borrower. Sample GUIs of the borrower web portal or application are illustrated in FIGS. 6A-E.

Upon entering initial borrower data and submitting the data through a GUI of the borrower web portal 420, the borrower device 150 transmits the data to the lending system 200. The initial borrower data includes a plurality of business metrics and requested loan information, such as loan amount. At step 504, based on the initial borrower data, without requiring a user account or user login into a user account of the lending system 200, the lending system 200 compares the initial borrower data against loan profiles defined by participating lenders. When the initial borrower data is matched with a loan profile of a participating lender, the lending system 200 further may transmit loan terms from the matched profile at 504. The loan terms may include loan amount, maturity, interest rate and monthly payment. The lending system 200 thus performs these functions for an unknown user, e.g. a user without a user account or a user not logged into the lending system 100.

The borrower may then enter loan application parameter data, such as timeline to close a pending loan application, loan amount, loan duration, loan guarantees, loan interest rate, loan interest rate nature (e.g., adjustable, fixed, scaled, etc.), etc. and be compared against the loan profiles defined by participating lenders. The lending system 200 compares the updated borrower data against loan profiles defined by participating lenders and updates the loan terms.

Upon request of the borrower, the lending system 200 at step 506 generates an online borrower profile or account. The lending system 200 stores any previously entered data into the borrower's account in the borrower database 220 and generates loan application data 226 in the database 226. The lending system 200 may then obtain further data to generate a common loan application at step 506, e.g., from the borrower using GUIs in the web portal, application and/or uploaded to a secure folder designated for the loan application and/or borrower. The lending system 200 may further obtain data using APIs for one or more third-party systems, such as Quickbooks® or other accounting systems.

The lending system 200 may be adapted to discourage submissions of casual, non-serious loan applications by allegedly potential borrowers by requiring a loan applicant to pay a nominal application fee (e.g., $49 fee) to submit the application, with the possibility that the application fee may be refunded or applied against closing costs of a loan that is funded, to reduce dissuading more serious users from submitting applications due to the application fee. The platform may be adapted to include a referral system, allocating points for referrals (e.g., fifty (50) basis points (0.5%) per referral).

The lending system 200 determines whether the loan application is complete at step 508. For example, the lending system 200 determines whether required data for the loan application has been entered into the system. A loan specialist may review the loan application as well. When one or more required data inputs or documentation is not complete, the lending system 200 may generate a display or notification requesting the missing data or documents at step 510. A loan specialist may review the borrower data and provide input to the lending system 200 when the common loan application is complete at step 514. The lending system 200 then requires attestation of the borrower of the common loan application. The lending system 200 obtains the borrow attestation, e.g. by digital signature in the borrower web portal or using an online web service for digital document execution. The lending system 200 then changes a status of the loan application to “In Due Diligence” at step 516.

The lending system 200 may receive an indication of due diligence documents required, e.g. by a loan specialist, to support the business metrics or other information in the loan application. The lending system 200 may securely upload and store the due diligence documents and track the uploaded documents in one or more GUIs. Upon completion of due diligence, the lending system 200 may obtain and/or record a final attestation of the borrower at 518.

FIGS. 6A-E illustrate exemplary GUIs of the borrower web portal 420 and/or application in accordance with an embodiment of the lending system 200. The web portal 420 provides a front end interface for borrowers to access the functions of the lending system 200. The web portal includes web files, such as HTML files, Cascading style sheets (CSS) files or other types of files written using programming languages like Python, JavaScript, C#, C++, or other types of code. The web files are transmitted to web browsers, e.g., on the borrower devices 150a-c, and used to generate the GUIs shown herein. The GUIs initiate one or more functions, such as a series of commands to be performed, when a user triggers the function, such as by clicking an icon, inputting data, selecting a menu item, etc. The functions may initiate communications with the web server 230 and/or application server 100 to send data, request data or to perform calculations, to select an option, generate pop-up windows, or send additional web files to generate additional GUIs, etc. The web files also control the graphics of the GUI, such as the displayed data, user options, folders, bins, URLs, links, boxes, tabs, pop-ups dialogues, status bars, checklists, mouse-over texts, dropdown menus, dropdown value selectors, data entry fields, columns, rows, tables, pie charts, graphs, maps, dials, selection wheels, adjustment buttons (e.g., plus symbol and minus symbol), check boxes, radio buttons, breadcrumb trails, hierarchy arrows, sorts, filters, groups, subgroups, lists, sequences, ranks, hierarchies, selected options vs. not-selected options, highlighted vs. shaded options, included vs. excluded options, etc. The sample GUIs described herein are exemplary to illustrate the various functions of the lending system 200. Additional or alternate GUIs may be implemented by the lending system 200.

FIG. 6A illustrates an exemplary GUI of an initial or landing page of the borrower web portal 420 or application prior to entry of borrower data. The GUI 600 includes a selection of an industry 602 and selection of a loan type 604 and input fields for a zip code 606 and business metrics 608. In one example, the selection of loan types includes asset based loan (ABL), accounts receivables (A/R) Factoring, small business administration (SBA) loan, Equipment, Small Business Investment Company (SBIC) loan, Cash Flow, Junior/Mezzanine, or Venture/Revenue loans. The industry selections may include, for example, Agriculture, Forestry, Fishing and Hunting/Mining, Quarrying, and Oil and Gas Extraction, Utilities, Construction, Manufacturing, Wholesale Trade, Retail Trade, Transportation and Warehousing, Information, Finance and Insurance, Real Estate and Rental and Leasing, Professional, Scientific, and Technical Services, Management of Companies and Enterprises, Administrative and Support and Waste Management and Remediation Services, Educational Services, Health Care and Social Assistance, Arts, Entertainment and Recreation, Accommodation and Food Services, Other Services (except Public Administration), and Public Administration. The business metrics 608 may include, e.g., average monthly inventory value, year to date revenues, year to date pre-tax earnings, average monthly account receivables balance, last calendar year of pre-tax earnings, and use of proceeds.

The exemplary GUI 600 further includes an Education dashboard 618 that may include additional or other resources, such as education materials, including a financial dictionary, economic information about the state of the economy, information about industry trends, resources to help small businesses, information about regional trends, explanations of and benefits of small business lending practices, and academic reports on activities of small- & medium-sized business (“SMB”) market segments. Other resources could include options to sign into a user account, to contact the website, to obtain help, to peruse instructions, to view frequently asked questions (“FAQs”), and/or to learn more about the website and the company behind the website.

FIG. 6B illustrates an exemplary GUI 610 of the borrower web portal 420 upon entry of initial borrower data. The borrower still has not been required to create a user account or sign into a user account. The GUI 610 illustrates the selection of the industry 602, the loan type 604 and a loan use 612. The borrower has input business metrics 608 including one or more of: the previous twelve (12) months of revenue, previous twelve (12) months of pre-tax earnings, an accounts receivable balance, an inventory value, an estimated equipment value, an estimated real estate value, a cash balance, an average monthly cash balance, a current liabilities amount, an outstanding debt balance, a number of years in business, and a desired loan amount. The borrower need not yet enter or upload supporting documents or documentation to verify the information entered at this point in the process. In theory, the borrower may enter fictional values to see what options the lending system 200 may provide.

Using the initial borrower data (such as the business metrics, zip code, industry, loan use, loan type and target loan terms), the lending system 200 also determines matching loan profiles from the plurality of registered lenders. The lending system 200 displays target loan terms 628 from one or more of the matching loan profiles, such as loan amount, maturity, interest rate, and monthly payment.

The lending system 200 thus generates an initial indication of loan terms from one or more matching loan profiles and probability of obtaining the loan using the initial borrower data, e.g. with or without the borrower creating a user account or submitting an actual application. The borrower may then determine whether to proceed with a lengthy loan application in view of such terms. When the borrower decides to proceed, the borrower may select the “apply now” icon 620. The lending system 200 then initiates a loan application process to receive more information from the borrower.

FIG. 6C illustrates an exemplary GUI 630 of the borrower web portal 620 for entry of a loan application after creation of a borrower account and sign-in. The lending system 200 provides a menu 632 of types of data that need to be completed for the loan application, such as company info, tax & audit information, P & L metrics, Balance Sheet Metrics and Additional Documents. Upon selection of an item in the menu 632, one or more GUIs are generated to enter the type of data. In this example GUI 630, the company info tab is selected on the menu 632, and the GUI 630 displays various data fields for completion, such as company name, year formed, headquarter address, number of employees, business description, industry or subindustry, etc. The lending system 200 allows a borrower to have multiple loans in progress. A loan selection icon 638 allows the borrower to select one of the plurality of loans in progress and displays the data for that selected loan.

The borrower web portal 420 may include a main menu 642 that is displayed for navigation of the web platform and selection of various functions of the application. The main menu 642 includes options such a view of all loans in progress, current application, company profile, main dashboard, messages, education, and the loan simulator (e.g., such as GUIs 600 and 610). The main menu may also display an assigned loan specialist 644 to the loan application and/or the borrower account.

FIG. 6D illustrates an exemplary GUI 650 of the borrower web portal 620 for selection of a NBTS from a lender. Upon completion and attestation of the loan application by the borrower, the loan application is forwarded by the lending system 200 to a plurality of lenders with matching loan profiles. The number of matching loan profiles may be based on the Loan Matching score. For example, the Loan Matching score may need to exceed a minimum value (such as 60%) for the loan profile to “match” the loan application. Each lender with a matching loan profile may then view the loan application (through the lender web portal 440 as described in more detail herein) and generate a NBTS for the borrower in the lender web portal 440. As shown in GUI 650, the borrower may then view the plurality of NBTS 646 submitted by the plurality of lenders for the loan application. The borrower thus only needs to complete one loan application to obtain a review by a plurality of lenders and to receive a plurality of NBTS 646 from the plurality of lenders.

The GUI 650 may include a summary 648 of data from the NBTS, such as lender name, date created, status, amount, type, interest rate, maturity, amortization, estimated payment, fees, etc. The borrower may thus quickly determine those NBTS in the list that it wishes to review further, e.g., by selecting an offer package icon 650 to download further details. The borrower may also accept or decline the NBTS. Accepted and binding term sheets 652 may be listed separately. The GUI 650 may also display a loan application progress 654 which is described in more detail with respect to FIG. 6E.

FIG. 6E illustrates an exemplary GUI 630 of the borrower web portal 420 showing loan progress 654 in more detail. The lending system 200 tracks a progress of the loan application through a plurality of predefined stages 656, such as application review, non-binding offer, binding offer, due diligence, and closed. The lending system 200 may also track progress of substages 658 to the main predefined stages 656. For example, the stage 656 of “non-binding offer” includes a plurality of substages 658 of non-binding offer, non-binding offer approval, non-binding offer review and offer accepted. The GUI 630 may indicate which process stages 656 and substages 658 have been completed and which remain to be completed, and the user needing to complete certain substages 658, such as the lender, the borrower or the loan specialist. The lending system 200 may also display an overall loan progress percentage 662 of the loan application. A borrower may thus track and manage a progress of its loan applications via the borrower web portal 240.

Other options in the borrower web portal 420 may include to view and/or to edit a borrower profile; to view and/or to send system messages within the portal; to view and/or to edit saved information; to view and/or to edit saved loan applications; to review and/or to submit ready loan applications; to check, to update, and/or to process pending loan applications; to finalize and/or to sign ready loan offers; to manage, to select, to view, to upload, to download, to edit, to create, to save, and/or to delete saved information, saved files, and/or saved documents; to manage and/or to receive payment of loan proceeds; to manage and/or to make loan payments; to view and/or to manage pending, completed, funded, and/or repaid loans; and to exit, log off, and/or sign out of the website and/or user account.

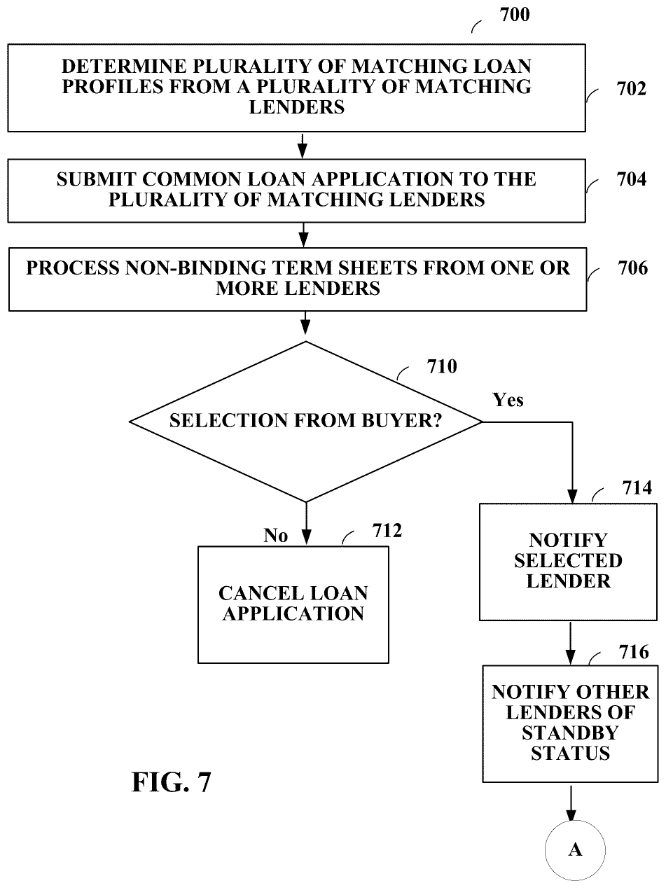

FIG. 7 illustrates a flow chart of an exemplary embodiment of a method 700 for processing a completed loan application by the lending system 200. When a loan application has been completed and final attestation received by the lending system 200, e.g. as described with respect to FIG. 5, the loan system 200 determines a plurality of matching loan profiles. The plurality of matching loan profiles may be associated with one lender account or a plurality of lenders accounts.

The lending system 200 determines the matching loan profiles at 702. The determination may be based on one or more required parameters that must be matching (such as, type of loan, loan amount, loan rate, minimum credit rating, etc.) and a number of other matching parameters. The borrower and/or lender may select the required parameters that must be matched for notification. A minimum loan matching percentage (such as 60% of the parameters) may be determined by the lender and/or lending system 200. The lending system 200 then determines the matching loan profiles at 702.

The lending system 200 then notifies lenders with matching loan profiles at 704. The notifications may be implemented using an automated mailbox application and/or in the lender web portal 440. The lending system 200 also provides access to the loan application to the lenders with matching loan profiles. For example, authorized users for the registered lender account may access the loan application through the lender web portal 440 upon authentication and/or sign in to the lending system 200.

The lending system 200 provides customizable templates to participating lenders to create the lender's personalized loan application templates. The lending system 200 propagates the loan application data from the borrower into the lender's customized loan application template. In addition, participating lenders may maintain and utilize their own formula spreadsheets for loan calculations, and the lending system 200 may be adapted to save, manage, and utilize such formulas, spreadsheets, and calculations. The lending system 200 may also support exporting participating lenders' formula templates to Excel® spreadsheets for offline data entry and later uploading to the online lender web portal 440.

When a loan application is accessed by a matched lender account, the lending system 200 changes a status of the loan application to “In Review” in the lender web portal 440. The matched lenders may then submit non-binding term sheets (NBTS) via the lending system 200 at 706. The lender web portal 440 may provide a GUI with data fields to enter the data in the non-binding term sheet data. The platform may also present one or more GUIs in which the lender can securely upload supporting documentation to a designated drop box, such as a secure private folder, e.g., on one or more of the memory devices 102a-b. For example, the lending system 200 may provide a GUI on the lender web portal 440 for input or selection of one or more parameters, such as loan amount, amortization, monthly payment, total fees, # of covenants, interest rate, closing date, lender rating, etc. The NBTS may also be uploaded to the secure folder designated for the loan application and/or borrower account. To facilitate and promote prompt action by matching lenders, the lending system 200 may provide the matching lenders a limited response time (such as 3-5 days) to submit a NBTS and then close the opportunity after expiration of such response time.

The lending system 200 processes the data of the NBTS at 306, such as by determining that the NBTS matches the required parameters. For example, a loan specialist may review and approve the NBTS of a lender prior to forwarding it to a borrower. The lending system 200 notifies the borrower account of the one or more NBTS from one or more lenders and provides access to the NBTS to the borrower account. The lending system 200 may wait to provide access to the borrower of all the NBTS after the submission deadline in a single presentation, e.g. to reduce the potential advantage possibly created by being the first lender to respond.

The borrower then has an opportunity to review competing NBTS from a plurality of lenders by completing a single loan application. If the borrower decides not to further pursue the loan application at 710, the lending system 200 changes a status of the Loan Application to “Failed/Declined” at 712 and notifies the matched lenders.

If the lending system 200 receives a selection of one of the NBTS from the borrower at 710, the lending system 200 notifies the selected lender at 714 and changes a status of the loan application to “in underwriting” for the selected lender. The lending system 200 further notifies the one or more non-selected lenders and changes a status of the loan application to “stand-by status” for the non-selected lenders at 716.

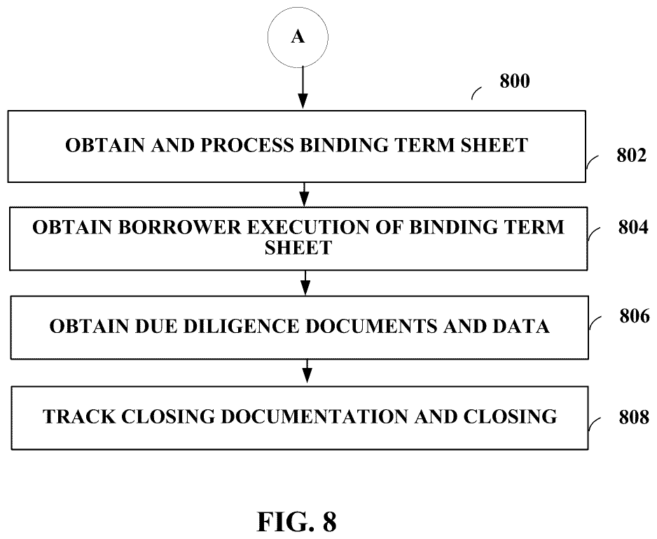

FIG. 8 illustrates a flow chart of an exemplary embodiment of the method 800 for processing a loan application in underwriting by the lending system 200. During the underwriting and closing processes, the lending system 200 performs tracking, status updates, and secure document exchange between the selected lender and borrower. For example, a dashboard GUI on the loan specialist web portal 430 may indicate which stages and/or substages in the loan process have been completed and which remain to be completed. The GUI may include one or more steps needed to complete a stage or substage, such as, for instance, the lender and the borrower orally discussing the details; the lender requesting additional information; the borrower providing requested information; the lender and the borrower reading, revising, and reviewing the final loan terms; the lender and the borrower each having attorneys read, revise, and review the final loan terms; the lender and the borrower each signing and executing the binding term sheet of the loan terms; the lender completing due diligence and underwriting of the loan; the attorney of the lender and the attorney of the borrower completing attorney review; the lender and the borrower closing the applied-for loan; the lender and the borrower signing and executing the promissory note; and the lender releasing the loaned funds.

Referring back to FIG. 8, at 802, the lending system 200 obtains the binding term sheet from the lender and provides access to the binding term sheet to the borrower. At 804, the lending system 200 may facilitate execution of the binding term sheet, e.g. using an online service for digital execution of documents. At 806, the lending system 200 may provide a secure folder for due diligence documents and a checklist of required due diligence documents for the borrower. The lending system at 808 may track completion of closing documents, facilitate execution of the closing documents, and store executed closing documents.

In accordance with an exemplary privacy policy stated on the portal, the platform may be adapted to save entered data and communications. Other disclosures may include, for example, that the platform may be adapted to receive a one percentage point (1%) origination fee from each loan consummated through the platform. In an exemplary embodiment, the platform may be adapted to charge the origination fee to the borrower and collect the origination fee upon funding of the loan.

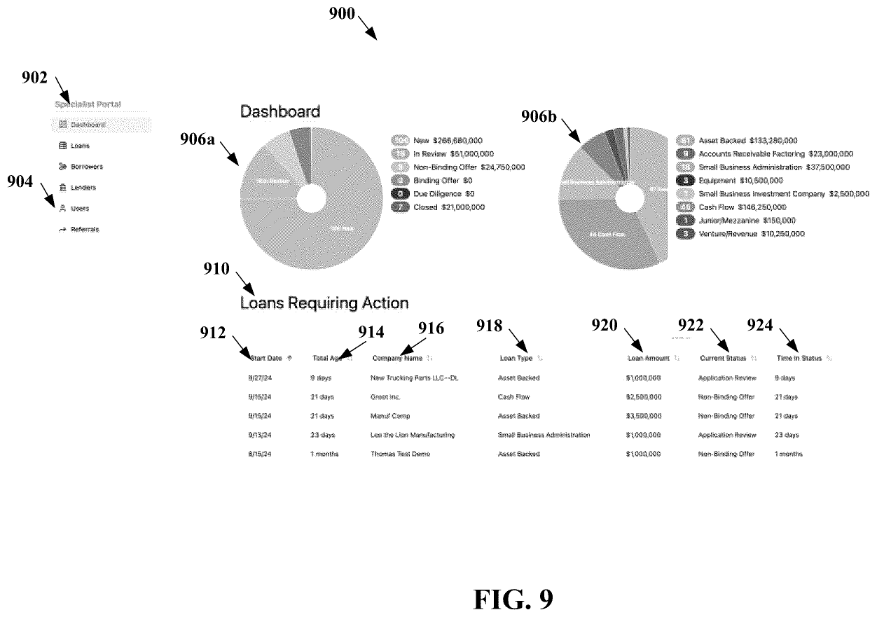

FIGS. 9-11 illustrate exemplary GUIs in the loan specialist web portal 430 generated by the lending system 200 in accordance with an embodiment. The loan specialist web portal 430 provides loan specialists with screens and dashboards tailored to the roles and needs of loan specialists, e.g., as an agent of the company providing the lending service to the borrowers and lenders. In one embodiment, the loan specialists are the operators of the loan system 200. In another embodiment, the loan specialists merely license the use of the loan system 200 from a third party operator.

Referring to FIG. 9, it illustrates an exemplary GUI 900 of a dashboard of the loan specialist web portal 430 or application. The GUI 900 includes a main menu 904 of the Loan Specialist web portal 430. The main menu 904 shows that the “dashboard” is selected. The dashboard includes one or more overview reports 906a-b summarizing the status of the plurality of loans to the plurality of companies from the plurality of lenders being handled by the lending system 200. The first overview report 906a is in the form of a pie chart that shows a status and percentage of the total loan applications at that status. The statuses include, e.g., New, In Review, Non-Binding Offer, Binding Offer, Due Diligence, and Closed. The second overview report 906b is also in the form of a pie chart and illustrates the types of loan and percentages thereof. The lending system 200 generates the overview reports 906a-b using one or more databases, such as lender database 210 and borrower database 220.

The GUI 900 also illustrates a Loans Requiring Action report 910 generated by the lending system 200. The Loans Requiring Action report 910 includes a start date 912, total age 914, an identification of the borrower (such as the company name) 916, loan type 918, loan amount 920, current status 922, and time in status 924. The lending system 200 thus tracks the loan application through each of a plurality of predefined progress steps and provides an updated status of the progress steps. A Loan Specialist can thus quickly determine the completed progress steps and the next steps required in the loan application. The GUI 900 provides a link to view the individual Loan Applications at each progress step.

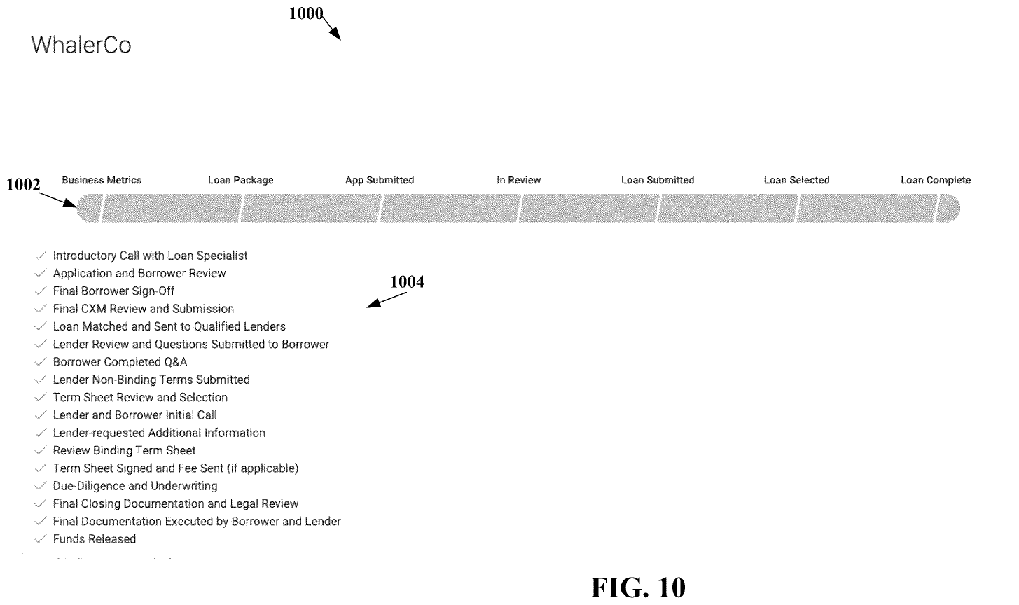

FIG. 10 illustrates an exemplary Detailed View of Loan Progress GUI 1000 generated by the lending system 200 in the loan specialist web portal 430 or application. The GUI 1000 displays a status bar 1002 including a series of predefined steps in the loan progress, including, e.g., business metrics, loan package, application (app) submitted, in review, loan submitted, loan selected, and loan completed. The GUI 1000 may also include actions required to be performed by the loan specialist during the loan progress. The lending system 200 thus tracks progress steps and actions required of a loan specialist during the loan application.

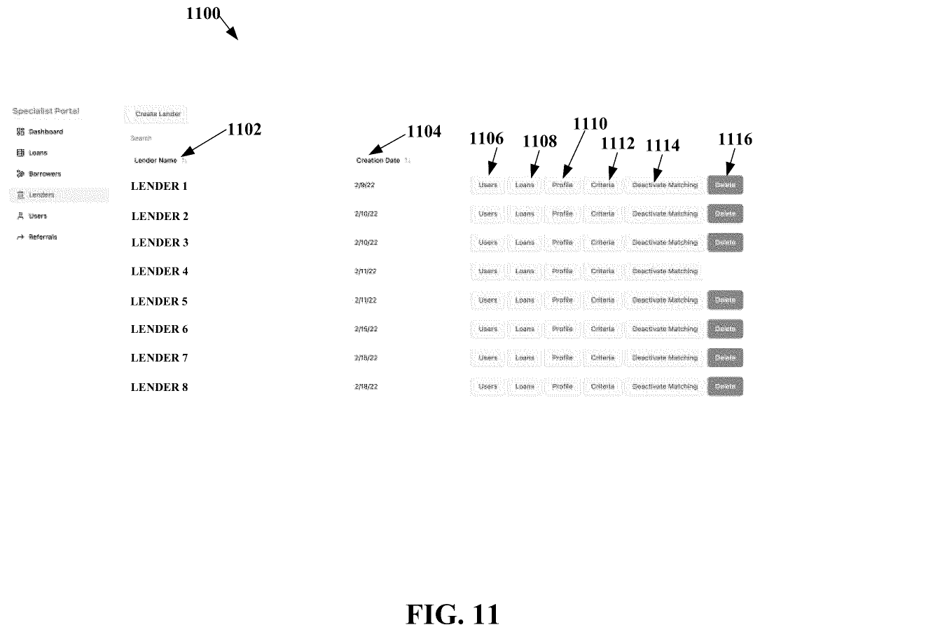

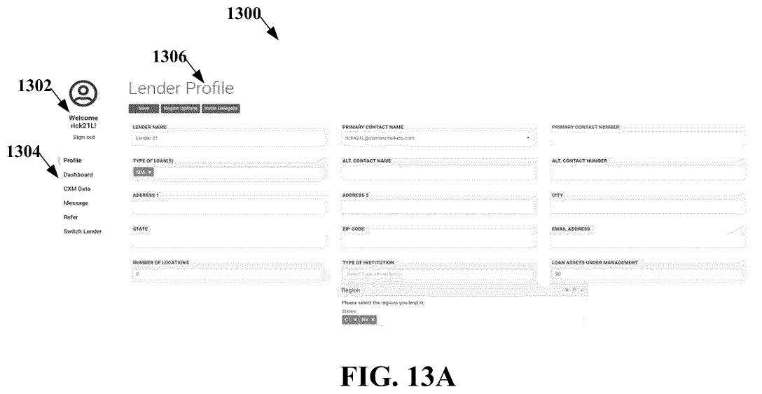

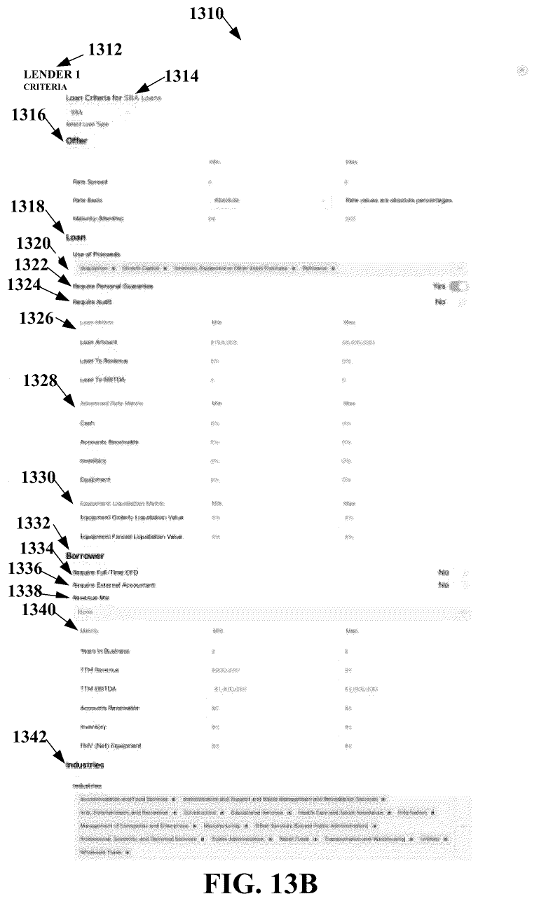

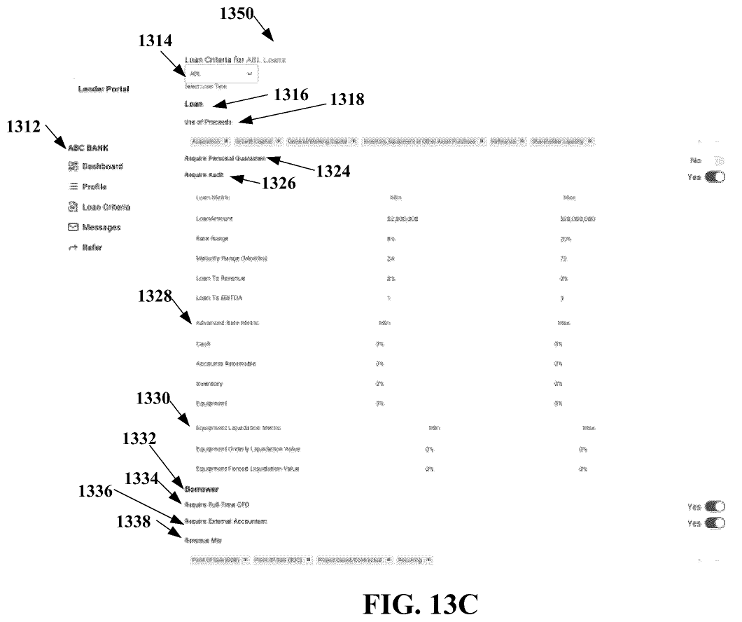

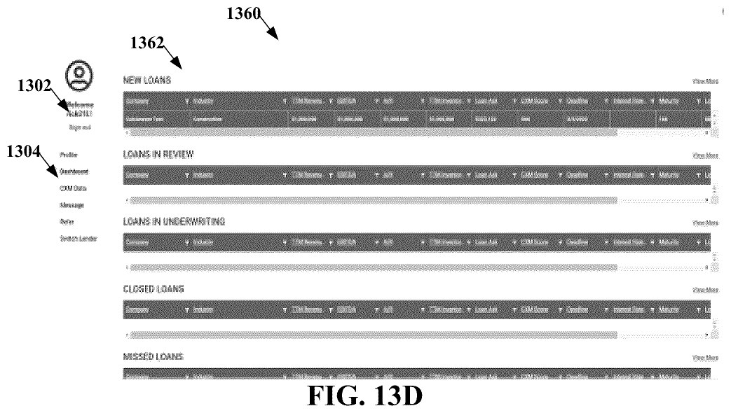

FIG. 11 illustrates an exemplary Lenders GUI 1100 generated by the lending system 200 in the loan specialist web portal 430. The Lenders GUI 1100 includes an identification 1102 of a plurality of lenders registered with the lending system 200 and a creation date 1104 of their registration. For each of the lenders, the GUI 1100 further includes a link to view an identification of users 1106 authorized to use the lending system, e.g., with user accounts under the lenders account, the loans 1108 in progress and completed by the lender, a profile 1110 of the lender, and criteria 1112. The criteria 1112 includes a list of loan profiles of the lender as shown in more detail with respect to FIGS. 13B-C.

The GUI 1100 includes a deactivate matching icon 1114 that initiates a process to remove the lender from matching one or more types of loans. For example, a lender may have too many loans in progress and need to deactivate initiating further loans for a period of time. In another example, a lender may not have further funds for SBA loans but may continue matching with other types of loans. So, matching is only deactivated for the SBA loan profiles of the lender. The GUI 1100 further includes a delete icon 1116 to remove the lender from the lending system 200.

The lending system 200 thus generates a loan specialist portal 430 that provides access to one or more loan applications relevant to the loan specialist. The lending system 200 provides GUIs showing the status for the relevant loan applications and their respective status in the application process. The lending system 200 generates and displays action item lists having actions required of the loan specialist, such as interviewing a loan applicant, or following up on a reference check. The lending system 200 provides a GUIs with view of applications at different process steps, such as, for instance, loan applications under review, in due diligence, by lender response status, by borrower response status, by term sheet status, by approval status, by execution or closing status, by funding status, by repayment status, by collection status, etc. The loan system 200 generates GUIs for the loan specialists web portal to view applications by status, which may include new loan applications, loan applications in review, loan applications in underwriting, loan applications awaiting closing, loans that have closed. Other status types may include loans in repayment, loans in default, loans in collection, failed loans, declined loans, and missed loans.

A dashboard in the lender web portal 430 may indicate which process steps have been completed and which remain to be completed, and such steps might include, for instance, the lender and the borrower orally discussing the details; the lender requesting additional information; the borrower providing requested information; the lender and the borrower reading, revising, and reviewing the final loan terms; the lender and the borrower each having attorneys read, revise, and review the final loan terms; the lender and the borrower each signing and executing the final term sheet of the final loan terms; the lender completing due diligence and underwriting of the loan; the attorney of the lender and the attorney of the borrower completing attorney review; the lender and the borrower closing the applied-for loan; the lender and the borrower signing and executing the promissory note; and the lender releasing the loaned funds.

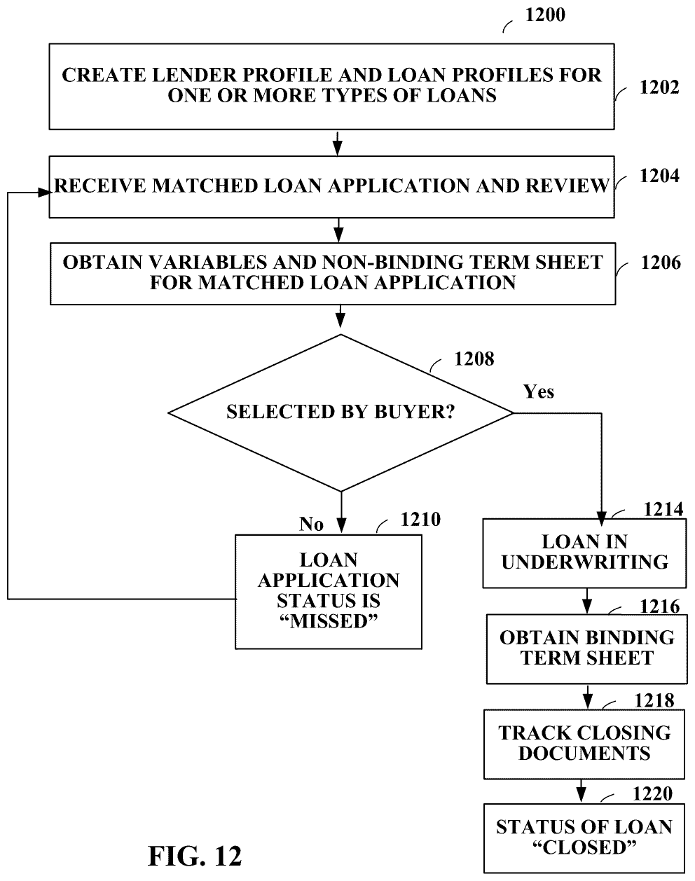

FIG. 12 illustrates a flow chart of an exemplary embodiment of a method 1200 of the lender web portal by the lending system 200. At 1202, the lending system 200 generates a lender account including a lender profile. The lender profile may include information on the lending institution, such as name, address, contacts information, regions served (e.g., states, countries, etc.) and type of loans offered by the lender. The lending system 200 further generates one or more loan profiles for the lender account. A loan profile for the lender account describes the borrower metrics and loan metrics for a type of loan. For example, the borrower metrics may include, e.g., a minimum number of years in business, permissible types of revenue (point of sale B2B, point of sale B2C, Project based/contractual, recurring, etc.), a range from minimum to maximum of TTM revenue, TTM EBITDA, Accounts Receivables, Inventory, FMV of Equipment, etc. The borrower metrics may further include whether a personal guarantee is required, whether the borrower is required to have a full-time CFO or an outside accountant to review financials. The borrower metrics thus specify requirements of a potential borrowers' business metrics, such as in minimum values (e.g., minimum revenue, minimum years in business), maximum values (e.g., maximum debt-to-income ratio), ranges of values (e.g., TTM revenue, TTM EBITDA), required inclusion criteria (e.g., must be in a particular U.S. State, must be U.S. Citizens, must provide personal guarantee, must have full-time CFO, must be in a certain industry, must have financial data reviewed and/or certified by an outside accountant or CPA), and exclusion criteria (e.g., exclusions of persons, such as no convicted felons; exclusions of industries such as no marijuana businesses).

The loan metrics include a range of potential loan amount, rate range, maturity range, a maximum loan to revenue percentage, or a maximum loan to EBITDA. The loan metrics may further include permissible uses of the proceeds or permissible industries. The loan profile thus provides an indication of loan amounts and terms offered by the lender for specified values of a plurality of business metrics of the borrower. The lending system 200 may generate multiple loan profiles for a lender account, e.g. a different loan profile for each different type of loan offered by the lender and/or multiple loan profiles for a specific loan type.

Upon completion of due diligence, the lending system 200 provides access to a loan application to lender accounts with matching loan profiles at 1204. The loan application will be assigned a “New Loan” status. The lending system 200 may also provide notification of the matched loan application, matched loan profile and a deadline for responding to the matched loan application. The lending system assigns the loan application a “Loan In Review” status when it detects that the lender account has accessed the loan application datafile.

When a participating lender wants to create and offer a loan proposal, the lending system 200 provides a GUI for entering one or more required variables of a non-binding term sheet (NBTS) in the lender web portal at 1206. For example, the lending system 200 may provide a GUI on the lender web portal for input or selection of one or more variables, such as loan amount, amortization, monthly payment, total fees, #of covenants, interest rate, closing date, lender rating. The lending system 200 may also receive an uploaded document for the NBTS in a secure folder. The lending system 200 stores and shares the variables for the NBTS with the loan specialist. The loan specialist may thus review the variables and NBTS, sort the NBTS using the variables, verify the variables meet the loan criteria, etc.

When a borrower fails to select the NBTS of the lender at 1208, the lending system 200 provides notification to the lender and changes a status of the loan application to “Missed” in the lender web portal at 1210. When the borrower selects the NBTS of the lender at 1208, the lending system 200 provides notification to the lender and changes a status of the loan application to “In underwriting” in the lender web portal at 1214. The lending system 200 then provides tracking and secure document exchange for the loan process. For example, at 1216, the lending system 200 obtains a binding term sheet from the lender and provides access to the binding term sheet to the loan specialist for processing and review by the borrower. The lending system 200 may also track status of closing documents at 1218. Once the loan has been funded by the Lender, the loan application then moves from “Loans In Underwriting” to “Closed Loans” at 1220. The lending system 200 thus provides tracking of progress of the plurality of loans for the lender.

FIGS. 13A-D illustrate exemplary GUIs generated by the lending system 200 in the lender web portal 430 or application. FIG. 13A illustrates a Lender Profile GUI 1300 in the lender web portal 430. The Lender Profile GUI 1300 includes an identification of an authorized user of the lending system 200 and an agent of the lender (such as an employee or contractor). The Lending Profile GUI 1302 further includes a main menu 1304 for the lender web portal 430 or application. The lender profile 1306 includes, e.g., name, address, contact information, regions served (e.g., states, countries, etc.) and type of loans offered by the lender.

FIG. 13B illustrates an exemplary Loan Profile GUI 1310 generated by the lending system 200 in the loan specialist web portal 430. The GUI 1310 provides for selection of a plurality of criteria or parameters for a loan profile by the lender. The loan profile includes an identification 1312 of the lender and a selection for the type of loan 1314 of the loan profile, such as an SBA loan type as in this example. The lender may select loan offer parameters 1316, such as rate spread, rate basis, and maturity. The lender may further select loan parameters 1318, such as use of proceeds 1320, whether a personal guarantee is required 1322, or whether an audit is required 1324. The loan parameters 1318 may further include loan metrics 1326, such as loan amount, loan to revenue, loan to EBITDA, and advance rate metrics 1328, such as cash, accounts receivable, inventory, equipment. The loan parameters 1318 may further include equipment liquidation metrics, such as equipment orderly liquidation value and equipment forced liquidation value. The lender may further select borrower parameters 1332, such as require full-time CFO 1334, require an external accountant 1336, and revenue mix 1338. The borrower parameters 1332 may further include different minimum or maximum financial metrics 1340, such as years in business, TTM Revenue, TTM EBITDA, accounts receivable, inventory, FMV net equipment, etc. The borrower parameters 1332 may also include requirements of certain industries 1342 of the borrower.

Once the lender completes their selections in the Loan Profile GUI 1310, the lender may submit the loan profile. The lending system 200 then saves the data as a loan profile 214 in the lender database 210. The lending system 200 then includes the loan profile 214 in comparisons to loan applications of prospective borrowers.

FIG. 13C illustrates another exemplary Loan Profile GUI 1350 generated by the lending system 200 in the loan specialist web portal 430. The GUI 1350 in this example provides for selection of a plurality of criteria or parameters for an ABL type loan 1314. The loan profiles may include different criteria and parameters for different loan types.

The lenders may thus input a loan profile for different types of loans. In addition, the lenders may input a plurality of loan profiles for a same type of loan. For example, one loan profile for an ABL loan may have a loan amount of a minimum of 1,000,000 to a maximum of $5,000,000 and require lower financial metrics of the borrower. Another loan profile of the same lender for an ABL loan may have a loan amount of a minimum of 5,000,000 to a maximum of $20,000,000 and require higher financial metrics of the borrower.

FIG. 13D illustrates an exemplary Dashboard GUI 1360 in the lender web portal. The GUI 1360 includes a report of the status of loan applications 1362 for a lender. For example, as shown, the loan status 1362 may include new loan applications, loan applications in review, loan applications in underwriting, closed loans and missed loans. Additional or alternative loan status may also be implemented, such as loans in repayment, loans in default, loans in collection, failed loans, or declined loans. The Dashboard GUI 1360 may provide details of the individual loan applications, deadlines, next steps in the process, etc. In addition, the lending system 200 may allow participating lenders to generate various reports on their loans, such as loan inquiry matches, loan inquiry match-to-application realizations, total assets under management (“AUM”), lender profile details, lender authorized user sub-profiles, and databases of associated supporting documentation.

The lending system 200 may permit lenders to customize various GUIs of the lender portal, such as to change data and data types that are collected and shown. The lending system 200 provides a new template function for creation of custom templates based on lender-specific criteria, custom metrics, loan types, and internal processes. Creation of custom metrics may allow a participating lender to track and analyze custom data types and fields of interest to the participating lender (e.g., if and how many borrowers operate service businesses in qualified economic development opportunity zones). Participating lenders may create multiple templates and assign different templates to different loan types and loan characteristics. Application-specific templates may be downloadable by a loan applicant for completion offline and to be uploaded to the system once completed.

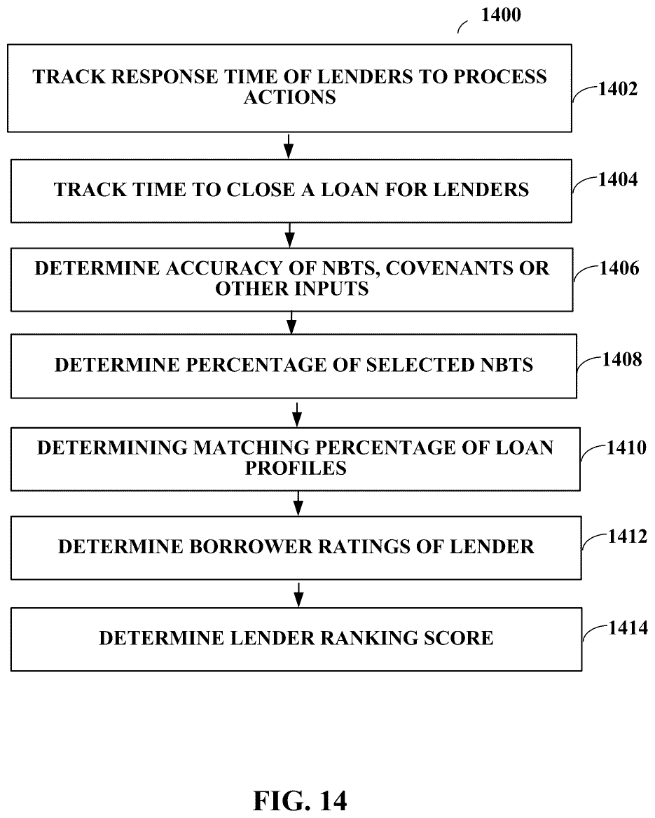

FIG. 14 illustrates a flow chart of an exemplary embodiment of a method 1400 for rating lender accounts in the lending system 200. The lending system 200 may obtain one or more parameters for rating a performance of a lender account. For example, at 1402, the lending system 200 may track a response time of a lender account to perform actions in a loan application process, such as providing documentation, submitting NBTS, etc. At 1404, the lending system 200 may track a time to close a loan by a lender account. At 1406, the lending system 200 may determine accuracy of data submitted by a lender account, such as accuracy of NBTS, covenants or other data inputs. The lending system 200 may determine a percentage that the NBTS of a lender account is selected by a borrower at 1408. The lending system 200 may further determine a percentage that a lender account has a matching loan profile at 1410. The lending system 200 may obtain feedback from borrowers with ratings of a lender account at 1412. These parameters relating to a lender's performance are exemplary and additional or alternative parameters may also be obtained.

The lending system 200 may determine a rating or ranking of a lender account using one or more of these parameters at 1414. The lending system 200 may provide feedback to a lender account of the parameters. The lending system 200 may provide the ratings and/or rankings to borrowers to assist in selection of a lender. The lending system 200 may cancel a lender account when a rating or ranking remains below a threshold for a predetermined duration.

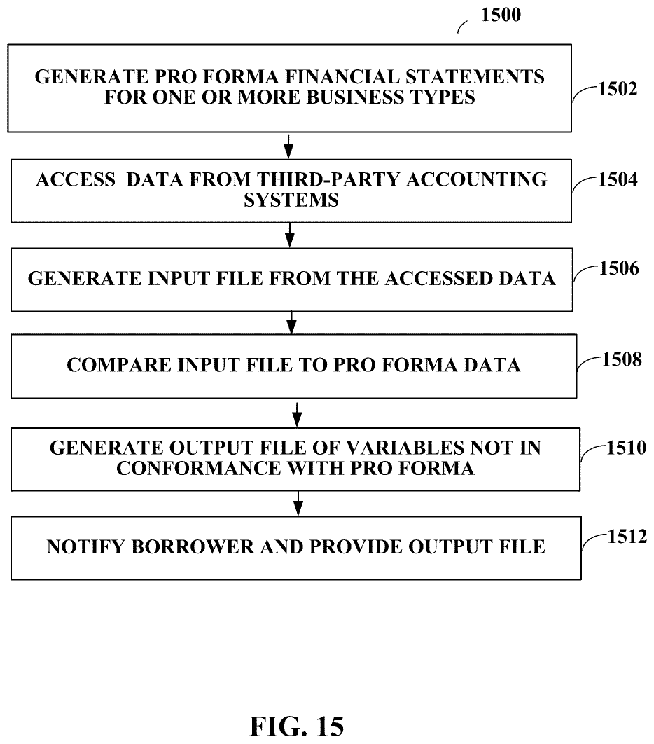

FIG. 15 illustrates a flow chart of an exemplary embodiment of a method 1500 for generating a borrower accounting file module. The borrower accounting file module may be accessed through the borrower web portal or application and create pro forma financial statements for one or more business types at 1502. For example, the pro forma financial statements may provide financial projections depending on varying loan amounts and rates.

The lending system 200 may incorporate the same or similar variables as third-party accounting systems, such as QuickBooks® application, into the pro forma financial statements. The lending system 200 may then access the third-party accounting systems and obtain borrower data at 1504. The lending system 200 may then generate an input file from the accessed data at 1506 and compare the data input from the third party accounting system and the pro forma data generated by the lending system at 1508. The lending system 200 may then generate an output file with any variables that are not the same or not within a predetermined margin of error at 1510. The lending system 200 may notify a borrower of the discrepancies and provide access to the output file to the borrower account at 1512.

### Exemplary Commercial Embodiments of a CMX™ System

An exemplary commercial embodiment is being brought to the market under the trademark “CXM™” as the CXM Loans™ solution, including an app, platform, and system. The CXM Loans™M solution is a proprietary application that enables streamlined loan applications and underwriting.

An objective of the CXM Loans™ solution is to provide a platform that enables connections between borrowers and loan lenders, and that reduces times needed to make such connections. The platform may be adapted to facilitate data acquisition from the potential borrowers and separately from the participating lenders. The platform may be adapted to host lenders, to interact with potential borrowers, and simultaneously to channel partners. Embodiments of the platform may be adapted to service different segments of the loan market, such as being adapted to facilitate connections or applications for commercial loans of $500,000 or more. The platform may be adapted to output proposed value propositions; to give information to potential borrowers, without the borrower needing to create a user account and logging in; and to thereby give potential borrowers complimentary information based on a loan application not yet supported with financial documentation. The platform may be adapted to provide real-time feedback to the potential borrower on proposed loan amounts and terms and matches from participating lenders that participate on the platform.

In some embodiments, after a potential borrower enters minimum data needed to generate proposed loans proposals, the platform may be adapted to prompt the potential borrower to create a platform account and save the potential borrower's already-entered data to the platform. The platform may provide the user with various scores or probabilities, such as, a business financial health score, a credit rating, a FICO® score, a score that indicates a balance sheet health of the borrower and/or a loan probability score indicating the estimated probability of obtaining a loan. Participating lenders may access the platform and generate loan profiles of offered loans of the lender. The platform may output a number of matches to loan profiles of the participating lenders.

In an exemplary solution, after a potential borrower creates a user account on the platform, the platform may allow the potential borrower to submit a common loan application to a plurality of lending having matching loan profiles. The platform may be adapted to have a section in which participating lenders, potential borrowers, or partners can safely upload secure information. The potential borrower may be provided with a secure ‘cloud’ folder in which to upload and store supporting documentation, and the system may be adapted to offer to extract data, or receive a data extract, from an accounting application, such as QuickBooks® software, to provide a more complete data submission and reduce the volume of data entry required of the user. The platform may provide the entire loan application completion and submission processes online via an online portal. With the system adapted to automatedly request, collect, and digest a thorough financial analysis of a potential borrower, and present such thorough financial analysis to participating lenders, the system may expedite loan application consideration, approval or rejection, and funding of approved applications.

The platform may be adapted to enable each participating lender to create the lender's own loan templates, keeping and maintaining loan records on a platform lender portal.

A CXM™ app may be is based on the iOS® mobile device operating system, the Android® operating system, another operating system, and/or be an interface running in a browser window, and may run on a mobile handheld device, such as a smartphone, tablet or laptop, and/or on a headset. The CXM™ system leverages a combination of Mobile Development, Software Development, Application Development, Web Components, Data Optimization, Database Components, API Calls, and Networking Technology.

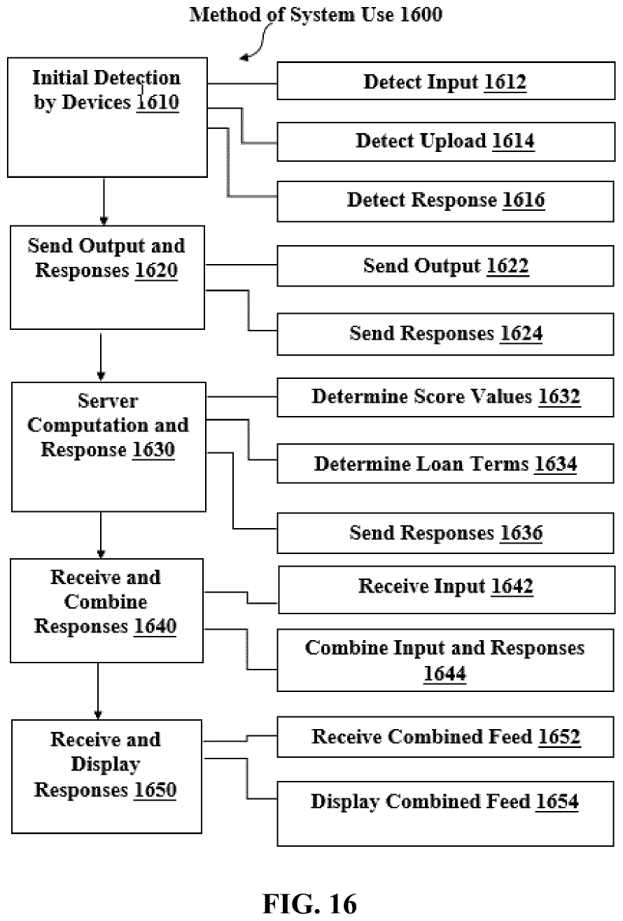

Referring to FIG. 16, it shows a block diagram of an exemplary embodiment of a method 1600 of use of an exemplary online loan application system 200 by one or more lender devices 130, loan specialist devices 140, or borrower devices 150 (hereinafter “user devices”), according to aspects of the invention. In the method 1600 as depicted in FIG. 16, a user device may perform a step 1610 of initial detection. The initial detection step 1610 may include, for instance, detecting 1612 an input, such as a loading of a webpage or app screen of the lending system 200; detecting 1614 an upload of information or data, such as in which the information is detected during a browser session; and detecting a response 1616, such as to button selections made by a user in the graphical user interface (“GUI”) on the webpage or screen of a web portal of the lending system 200. The method may further include performing at step 1620 the transmission of inputs, uploads, or responses to the application server 100, such as via an auxiliary processor unit. This transmission step 1620 may include sending 1622 the browser data from the user device to the application server 100, and sending 1624 the information or button selections from the user device to the application server 100, for calculations and determinations. The lending system 200 may perform a step 1630, e.g. at the application server 100, of server computation and response to the transmission step 1620. This computation and response step 1630 may include determining 1632 scores or probabilities, such as, a business financial health score,, a score that indicates a balance sheet health of the borrower and/or a loan probability score indicating the estimated probability of obtaining a loan, or determining 1634 loan terms of matching loan profiles, and sending 1636 the responses to the user device. The user device may at step 1640 receive and combinate responses from the application server 100. The receipt and combination of responses step 1640 may include receiving 1642 the loan terms of matching loan proposals, and combining 1644 the inputs and responses. The user device may perform the step 1650 of receipt and display of the responses. The receipt and display step 1650 may include receiving 1652 the combined feed comprising the server-based content, and displaying 1654 the combined data on the display of the console, e.g. using a web browser.

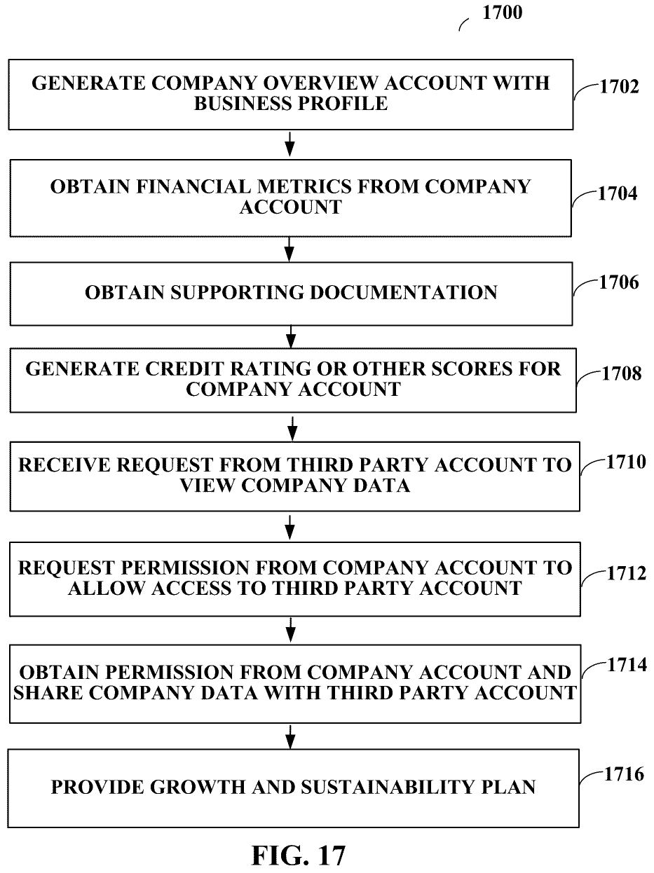

FIG. 17 illustrates a flow chart of an exemplary embodiment of a method 1700 of the lender system 200 for generating a company overview service. In an embodiment, the financial metrics and supporting documentation function may be used by companies for purposes other than obtaining a loan. For example, an original equipment manufacturer (OEM) often needs reassurances about the financial health of its potential suppliers, especially long term suppliers. The suppliers generate a “Company Overview” or “Supplier” account in the lending system 200 and grant access to view their profile to the OEM. The OEM may then more easily evaluate the financial health of its suppliers.

At 1702, the lending system 200 generates a company overview account for a company. A company profile, similar to the borrower profile, is created for the company. The company profile may include company name, year formed, headquarter address, number of employees, business description, industry or subindustry, etc. At 1704, the lending system 200 obtains financial metrics of the company. The lending system 200 may generate a web portal with one or more GUIs for the company to input business metrics, e.g., similar to GUIs 6A-6B. At 1706, the lending system 200 may also provide a secure folder service 412 for upload of supporting documents with file sharing and synchronization services, such as DropBox® hosting service. At 1708, the lending system 200 may generate one or more financial scores for the company, such as a credit rating, business financial health score, a score that indicates a balance sheet health of the borrower and/or a loan probability score indicating the estimated probability of obtaining a loan, etc.

The company may now provide access to its profile, financial metrics, and supporting documentation to authorized third parties. For example, a third party creates a “Company View” account and requests access to view the data of the company account. The lending system 200 requests permission from the company to share its data with the third party account. The company may provide permission or deny permission to the third party. In an embodiment, the company may provide different levels of permission to access data. For example, a first level of permission may include access to the company profile. A second level of permission may include access to the financial metrics as well. When the lending system 200 obtains permission from the company at 1714, the lending system shares the company data with the third party account.

The lending system 200 may also generate and provide a growth and sustainability plan to the company using its financial metrics. The lending system 200 may advise on obtaining one or more types of loans for growth or stability of the company.

Although exemplary embodiments may refer to utilizing aspects of the presently disclosed subject matter in the context of one or more stand-alone computer systems, the subject matter is not so limited, but rather may be implemented in connection with any computing environment. Still further, aspects of the presently disclosed subject matter may be implemented in or across a plurality of processing chips or devices, and storage similarly may be created across a plurality of devices in the lending system 200.

The various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the claimed invention will be readily apparent to those of ordinary skill in the art. Accordingly, other embodiments may fall within the spirit and scope of the claimed invention, as defined by the claims that follow hereafter.

In the description above, numerous specific details are set forth in order to provide a more thorough understanding of embodiments of the invention. It will be apparent, however, to an artisan of ordinary skill that the invention may be practiced without incorporating all aspects of the specific details described herein. Not all possible embodiments of the invention are set forth verbatim herein. A multitude of combinations of aspects of the invention may be formed to create varying embodiments that fall within the scope of the claims hereafter. In addition, specific details well known to those of ordinary skill in the art have not been described in detail so as not to obscure the invention. Readers should note that although examples of the invention are set forth herein, the claims, and the full scope of any equivalents, are what define the metes and bounds of the invention protection.

1. A lending system, comprising:
at least one memory device, wherein the memory device stores a database including a plurality of loan profiles generated by a plurality of lenders, wherein each of the plurality of loan profiles includes a loan type, loan metrics, and borrower metrics and wherein the loan type includes a type of commercial loan; and
at least one processing circuit, wherein the processing circuit is operatively coupled to the at least one memory device and wherein the at least one memory device stores instructions that, when executed by the at least one processing circuit, causes the lending system to:
obtain borrower data including a plurality of business metrics from a user device;
compare the borrower data to the plurality of loan profiles of the plurality of lenders;
determine at least one matching loan profile from the plurality of loan profiles;
determine loan terms from the at least one matching loan profile, wherein the loan terms include at least a loan amount and a loan rate; and
generate a graphical user interface (GUI) file for display on the user device, wherein the GUI file includes the loan terms.

2. The lending system of claim 1, wherein the lending system is further configured to obtain the initial borrower data including the plurality of business metrics from an unknown user of the user device, wherein the unknown user is not associated with an account in the lending system; and
display the GUI including the loan terms on the user device.

3. The lending system of claim 2, wherein the lending system is further configured to:
generate a borrower account including the initial borrower data;
generate loan application data using additional borrower data associated with a borrower account and store the loan application data in the at least one memory device; and
determine a plurality of updated matching loan profiles from the plurality of loan profiles stored in the at least one memory device using the loan metrics and the borrower metrics from the plurality of loan profiles and the loan application data.

4. The lending system of claim 3, wherein the lending system is further configured to:
determine a plurality of matched lenders associated with the plurality of updated matching loan profiles; and
provide access to the loan application data stored in the at least one memory device to lender accounts associated with the plurality of matched lenders.

5. The lending system of claim 4, wherein the lending system is further configured to determine the plurality of updated matching loan profiles by:
determining a matching score between the loan application data and each of the plurality of loan profiles;
comparing the matching score for each of the plurality of loan profiles to a minimum matching score; and
selecting the plurality of updated matching profiles with associated matching scores above the minimum matching score.

6. The lending system of claim 5, wherein the lending system is further configured to:
obtain and store a plurality of non-binding term sheets (NBTS) from a plurality of the matched lenders; and
provide access to the plurality of NBTS to the borrower account.

7. The lending system of claim 6, wherein the lending system is further configured to:
obtain a selection of one of the plurality of NBTS from the borrower account;
notify a selected lender associated with the selected one of the plurality of NBTS; and
notify a plurality of non-selected lenders of a stand-by status.

8. The lending system of claim 7, wherein the lending system is further configured to track a status of the loan application.

9. The lending system of claim 8, wherein the lending system is further configured to:
generate a customizable template for a loan application GUI;
receive updates to the customizable template from a lender account; and
generate an updated template for the loan application GUI for the lender account.

10. The lending system of claim 9, wherein the lending system is further configured to:
obtain one or more parameters relating to lender performance; and
generate a rating of a lender account using the one or more parameters.

11. The lending system of claim 10, wherein the lending system is further configured to:
generate a template of a pro forma financial statement for one or more business types;
extract data associated with the borrower account from a third-party accounting system; and
generate a pro forma financial statement for the borrower account using the extracted data and loan terms from the at least one matching loan profile.

12. The lending system of claim 1, comprising:
a web server including at least a network interface, wherein the web server communicates the GUI to a web browser on the user device; and
an application server coupled to the web server.

13. A lending system, comprising:
at least one memory device; and
at least one processing circuit, wherein the processing circuit is operatively coupled to the at least one memory device and wherein the at least one memory device stores instructions that, when executed by the at least one processing circuit, causes the lending system to:
generate a lender web portal for access by a plurality of lender accounts;
generate a plurality of loan profiles for each of the plurality of lender accounts, wherein each of the plurality of loan profiles includes a loan type, loan metrics, and borrower metrics and wherein the loan type includes a type of commercial loan;
generate loan application data using borrower data associated with a borrower account and store the loan application data in the at least one memory device;
compare the loan application data to the loan metrics and the borrower metrics in each of the plurality of loan profiles; and
determine a plurality of matching loan profiles from the plurality of loan profiles.

14. The lending system of claim 13, wherein the lending system is further configured to determine the plurality of matching loan profiles by:
determining a matching score between the loan application data and each of the plurality of loan profiles;
comparing the matching score for each of the plurality of loan profiles to a minimum matching score; and
determining the plurality of loan profiles with associated matching scores above the minimum matching score.

15. The lending system of claim 14, wherein the lending system is further configured to:
determine a plurality of matched lenders associated with the plurality of matching loan profiles; and
provide access to the loan application data stored in the at least one memory device to lender accounts associated with the plurality of matched lenders.

16. The lending system of claim 15, wherein the lending system is further configured to:
obtain and store a plurality of non-binding term sheets (NBTS) from the plurality of matched lenders; and
provide access to the plurality of NBTS to the borrower account.

17. The lending system of claim 16, wherein the lending system is further configured to:
obtain a selection of one of the plurality of NBTS from the borrower account;
notify a selected lender associated with the selected one of the plurality of NBTS; and
notify a plurality of non-selected lenders of a stand-by status.

18. The lending system of claim 17, wherein the lending system is further configured to:
obtain one or more parameters relating to lender performance for each of the plurality of lender accounts; and
generate a lender rating for each of the plurality of lender accounts.

19. The lending system of claim 18, wherein the lending system is further configured to:
generate a loan specialist web portal for access by a plurality of loan specialists; and
generate a GUI for the loan specialist web portal including a loan status for each of a plurality of loan applications associated with the plurality of lender accounts.

20. The lending system of claim 19, wherein the lending system is further configured to:
generate a GUI for the loan specialist web portal including a plurality of process steps and a status for each of the plurality of process steps for each of the plurality of loan applications associated with the plurality of lender accounts.
